(19) United States
(12) Patent Application Publication
(10) Pub. No.: US 2010/0318492 A1
(43) Pub. Date: Dec. 16, 2010

(54) DATA ANALYSIS SYSTEM AND METHOD

(75) Inventor: Kei UTSUGI, Tokyo (JP)

Correspondence Address: FOLEY AND LARDNER LLP;SUITE 500, 3000 K STREET NW, WASHINGTON, DC, 20007, US

(73) Assignee: Hitachi, Ltd.

(21) Appl. No.: 12/709,298

(22) Filed: Feb. 19, 2010

(30) Foreign Application Priority Data
Jun. 16, 2009 (JP) 2009-143733

(51) Int. Cl. G06F 17/30

(52) U.S. Cl. 707/603; 707/E17.032; 707/E17.056

(57) ABSTRACT

Provided is a technology capable of efficiently saving data generated at an intermediate stage of an analysis processing and reusing intermediate data. Data generated at the intermediate stage of the analysis is saved, quantified feedback information for the saved data is received as an evaluation value, and the intermediate data that has not been given an evaluation value is preferentially deleted while the analysis processing for similar data is performed with regard to the intermediate data that has received a particularly high evaluation value, thereby performing automatic management of the intermediate data by a background processing so that the analysis of data to be subjected to a comparison and a derivatively-assumed analysis can be performed at high speed.

### CLAIM OF PRIORITY

The present invention claims priority from Japanese patent application JP2009-143733 filed on Jun. 16, 2009, the content of which is hereby incorporated by reference into this application.

### BACKGROUND OF THE INVENTION

This invention relates to an apparatus and a method for performing a large-scale data analysis using a parallel distributed information processing environment and its visualization.

With establishment of a calculation processing environment at high speed and low cost, analyses regarding realization of efficiency in business work and optimization of facilities have been generally performed. Processings for those analyses need a heuristic process for finding/extracting a pattern from large-scale log data and creating a hypothetical model.

Such a large-scale data analysis based on the log data is not fully automated at present, and particularly at an initial stage of seeking a data relationship (correlation between data items), often needs to involve a human being in finding the correlation between data items or a pattern regarding temporal iteration. In this case, in order to find a breakthrough in an analysis, an analysis environment is necessary in which data processed by various techniques is visualized and presented to promote an intuitive understanding of a human being and feedback work by the human being is taken into a calculation process. Under such an environment, it is important to maintain compatibility between operability that allows a computer to support a human being so as to alleviate the load on him/her and efficient use of calculation resources. The data analysis as described above is known as data mining, known examples of which include JP 2008-204282 A and “Kazuhiro Matsumoto et al. “Parallel Data Mining System Architecture”, Technical Report of IEICE, Data Engineering Vol. 97, No. 417 (19971202), pp. 33-38, The Institute of Electronics, Information and Communication Engineers (incorporated association)”.

### SUMMARY OF THE INVENTION

However, in the above-mentioned conventional example, the analysis to which large-scale data is subjected at the initial analysis stage for a data pattern requires heavier calculation loads and more time in both a data extraction process and a process of an analysis processing as the size of the raw data increases, which inhibits interactivity for trial and error and requires a large amount of time to find a pattern.

While such a data processing is repeated, several different data processing processes may repeatedly execute a part of an analysis processing process on the same condition or a similar condition.

In this case, it may be possible to enhance the speed of the processing process for the second and subsequent times by retaining respective intermediate output results of process elements for reuse.

However, reuse of data reduces the load on a calculation processing, while a large volume of external storage space is consumed if too many results of intermediate processings are retained, which deteriorates efficiency in terms of cost performance in use of storage devices.

Further, only a subset obtained by narrowing down a database under a specific condition is often used as the raw data to be subjected to the analysis. In this case, possible combinations of intermediate data items explosively increase in number, which makes it difficult to judge under which condition the intermediate data is to be retained.

For those reasons, there exist a large number of problems in terms of cost performance when optimization is performed by managing the intermediate data assumed to be reused.

Therefore, this invention has been made in view of the above-mentioned problems, and an object thereof is to efficiently save data generated at an intermediate stage of an analysis processing and reuse intermediate data.

A representative aspect of this invention is as follows.

A data analysis system for analyzing raw data and outputting an analysis result by using a computer comprising a processor and a storage device, comprising: a raw data storage module for storing the raw data; an analyzing module for reading the raw data, performing an analysis thereon, generating intermediate data in a process of the analysis, and outputting the analysis result; an intermediate data storage module for storing the intermediate data generated by the analyzing module; and an evaluation receiving module for receiving an evaluation value regarding the analysis result output by the analyzing module, wherein: the analyzing module references usable intermediate data among the intermediate data within the intermediate data storage module at a time of the analysis; and the evaluation receiving module distributes the evaluation value to the intermediate data corresponding to the evaluation value, and if the distributed evaluation value satisfies a predetermined condition, deletes the intermediate data corresponding to the evaluation value.

According to this invention, it is possible to realize a high speed analysis processing using the intermediate data

These and other features, objects and advantages of the present invention will become more apparent from the following description when taken in conjunction with the accompanying drawings.

### BRIEF DESCRIPTION OF THE DRAWINGS

FIG. 1 is a block diagram illustrating an example of an analysis system according to a first embodiment of this invention.

FIG. 2 is a block diagram illustrating an example of a mechanism for realizing such a standard information processor according to a first embodiment of this invention.

FIG. 3 is a block diagram illustrating an example of a data analysis processing according to a first embodiment of this invention.

FIG. 4 is a flowchart illustrating the process for a case where the analysis is executed by the user explicitly inputting the contents of the data analysis through the analysis processing input program according to a first embodiment of this invention.

FIG. 5 illustrates a data structure for retaining the data analysis flow inside a computer according to a first embodiment of this invention.

FIG. 6 is a flowchart illustrating processing steps performed by the analysis server according to a first embodiment of this invention.

FIG. 7 illustrates a management table for managing the input data items according to a first embodiment of this invention.

FIG. 8 is a flowchart executed by analysis server PC for judging a congruence or similarity between the analysis data and the partial analysis flow processing script according to a first embodiment of this invention.

FIG. 9 is a flowchart illustrating a series of procedures for executing an analysis processing instance by the child analysis server according to a first embodiment of this invention.

FIG. 10 illustrates an example of a data structure 1100 for realizing the distance function between element data items and the divided set for sampling according to a second embodiment of this invention.

FIG. 11 illustrates a tree structure for management space information according to a second embodiment of this invention.

FIG. 12 is a flowchart illustrating a processing process of the scheduler program 2101 running on the analysis server PC 210 according to a first embodiment of this invention.

FIG. 13 is a flowchart illustrating a processing in which the scheduler program 2101 on the analysis server PC 210 performs recalculation of the evaluation value of the intermediate data in Step 1304 of FIG. 12 according to a first embodiment of this invention

FIG. 14 is a flowchart illustrating details of the processing of steps for generating the script of the data analysis flow similar to the intermediate data according to a second embodiment of this invention.

FIG. 15 is a flowchart illustrating details of the processing of steps for redistributing evaluation value according to a second embodiment of this invention.

FIG. 16 is a flowchart illustrating details of the processing of judging whether or not the calculation cost of the new data can be omitted by reusing the intermediate data according to a first embodiment of this invention.

FIG. 17A illustrates a tree structure by reusing the intermediate data according to a first embodiment of this invention.

FIG. 17B illustrates a tree structure by reusing the intermediate data according to a first embodiment of this invention.

FIG. 18 is a flowchart for judging a congruence or similarity between the analysis data and the partial analysis flow processing script according to a third embodiment of this invention.

FIG. 19 is a block diagram illustrating programs executed on the information processors and a flow of messages exchanged among the programs according to a first embodiment of this invention.

FIG. 20 is a block diagram illustrating the relation of the programs according to a second embodiment of this invention.

FIG. 21 is a block diagram illustrating a configuration of the fifth embodiment of this invention.

FIG. 22 illustrates an example of a screen of the visualization program 2300 according to a fifth embodiment of this invention.

FIG. 23 illustrates a data structure as a return value according to a first embodiment of this invention.

FIG. 24 is a flowchart executed by cache DB for judging a congruence or similarity between the analysis data and the partial analysis flow processing script according to a first embodiment of this invention.

FIG. 25 illustrates an example of a display image generated by the visualization module according to a first embodiment of this invention.

FIG. 26A illustrates a visualization module of the analysis server PC according to a first embodiment of this invention.

FIG. 26B illustrates a visualization module of a client PC according to a first embodiment of this invention.

FIG. 27 illustrates a data structure for accumulating difference information according to a third embodiment of this invention.

### DETAILED DESCRIPTION OF THE PREFERRED EMBODIMENTS

Hereinafter, description is made of optimal embodiments for realizing this invention with reference to the accompanying drawings.

(Overall Configuration)

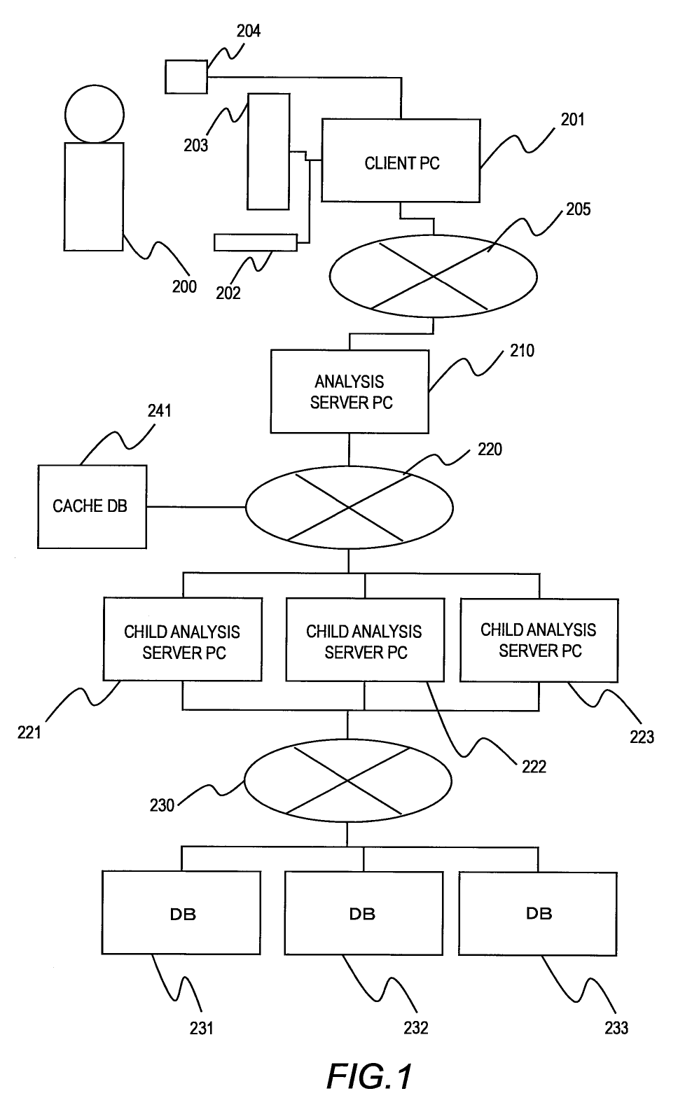

FIG. 1 is a block diagram illustrating an example of an analysis system according to a first embodiment of this invention.

A client PC 201 functions as a user interface of a user 200, and is an information processing device for receiving an input from the user 200 and outputting processing results to a screen.

The client PC 201 includes input/output means with respect to an interface device 202 including a keyboard and a mouse for receiving the input from the user 200, a display device 203 for outputting an image or a character string that indicates a result to the user, and a camera device 204 for photographing facial expressions and actions of the user 200.

An analysis server PC 210 is an information processing device for processing a message on an analysis processing process transmitted from the client PC 201 via a network 205, extracting data within a range corresponding to contents of an analysis, and returning a notification of a result of performing an information processing on the extracted data to the client PC 201.

Child analysis server PCs 221 through 223 are information processing devices for performing a processing after receiving a partial problem (part of the information processing) of the contents of the information processing performed by the analysis server PC 210 therefrom via a network 220. FIG. 1 illustrates the three child analysis server PCs 221 through 223 as child analysis servers, but the number of the child analysis servers may increase to enhance calculation throughput.

Databases (hereinafter, referred to as “DBs”) 231 through 233 are information processing devices connected to the child analysis server PCs 221 through 223 via a network 230, for retaining a large volume of raw data to be subjected to the analysis in a storage system and for extracting and transmitting a part of the retained data in response to a request including a constraint described later. In addition, a cache DB 241 is an information processing device connected to the analysis server PC 210 and the child analysis server PCs 221 through 223 via the network 220, for realizing a function of temporarily archiving data obtained after having been subjected to an analysis processing by the analysis server PC 210 and the child analysis server PCs 221 through 223. It should be noted that the raw data represents data previously collected for performing the analysis.

(Configuration of Information Processing Device)

The components including the client PC 201, the analysis server PC 210, the child analysis server PCs 221 through 223, the DBs 231 through 233, and the cache DB 241 are implemented by using a standard information processors.

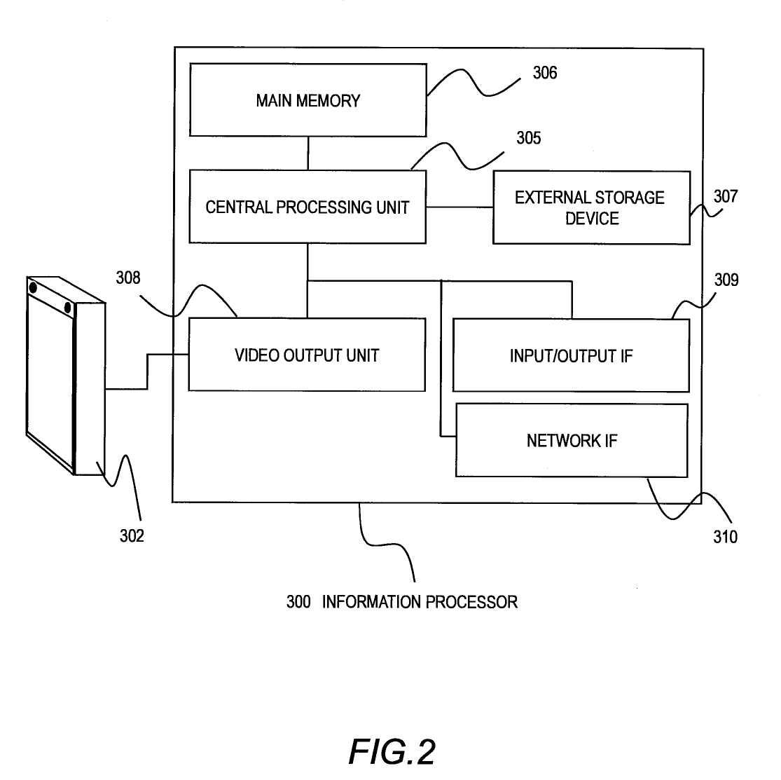

FIG. 2 is a block diagram illustrating an example of a mechanism for realizing such a standard information processor 300. The information processor 300 includes the components including a central processing unit 305, a main memory 306, an external storage device 307, a video output unit 308 for creating an image to be displayed to an external portion, an external input/output interface 309, and a network interface 310.

Those information processing devices are implemented in conformity with various kinds of existing devices implemented as a general-purpose computer. Further, a general-purpose external device control interface such as USB is used as the external input/output interface 309. Further, the information processing devices exchange messages with one another via the network interface 310, and such a network is implemented by using an existing protocol such as TCP/IP for exchanging messages.

(Flow and Process of Messages)

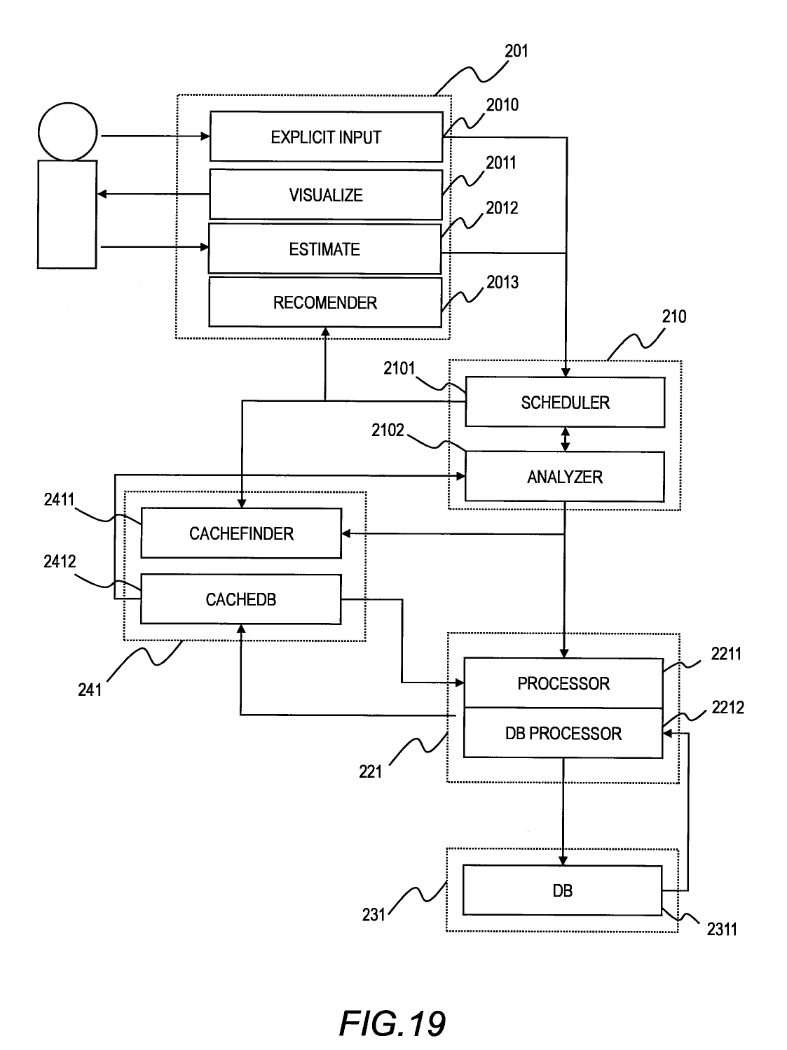

FIG. 19 illustrates programs executed on the information processors including the client PC 201, the analysis server PC 210, the child analysis server PCs 221 through 223, the DBs 231 through 233, and the cache DB 241 and a flow of messages exchanged among the programs.

On the client PC 201, an analysis processing input program 2010, an analysis result presenting program 2011, an evaluation result input program 2012, and a recommended analysis processing presentation program 2013 are read into the main memory 306 and respectively executed asynchronously by the central processing unit 305, and a message and an input are received through the external input/output interface 309 and the network interface 310 to perform an information processing.

On the analysis server PC 210, a scheduler program 2101 and a data analysis program 2102 are read into the main memory 306 and respectively executed asynchronously by the central processing unit 305, and a message and an input are received through the external input/output interface 309 and the network interface 310 to perform an information processing.

The child analysis server PC 221 receives the message from the data analysis program 2102 of the analysis server PC 210, reads a predetermined data analysis module 2211 or a predetermined data extraction process 2212 specified in the message into the main memory, and performs an information processing by using the central processing unit 305. In this case, if there exist a plurality of child analysis server PCs 221 through 223 that can perform a processing, the data analysis program 2102 assigns parts of the contents of a data analysis processing to the child analysis server PCs 221 through 223 according to a procedure described later.

On the DB 231, a data management program 2311 for reading the saved raw data from the external storage device 307 for transfer thereof is read into the main memory 306, and a message and an input are received through the external input/output interface 309 and the network interface 310 to perform extraction of necessary data and a transfer processing.

On the cache DB 241, a cache data search program 2411 for registering saved internal data (intermediate data) and searching for similar intermediate data and a cache data management program 2412 for reading cache data from the storage device for transfer thereof are read into the main memory 306 and respectively executed asynchronously by the central processing unit 305, and a message and an input are received through the external input/output interface 309 and the network interface 310 to perform an information processing.

Hereinafter, description is made of a cooperative processing of those programs and the process of the analysis processing.

(Definition of Description Format (Script) for Analysis Task)

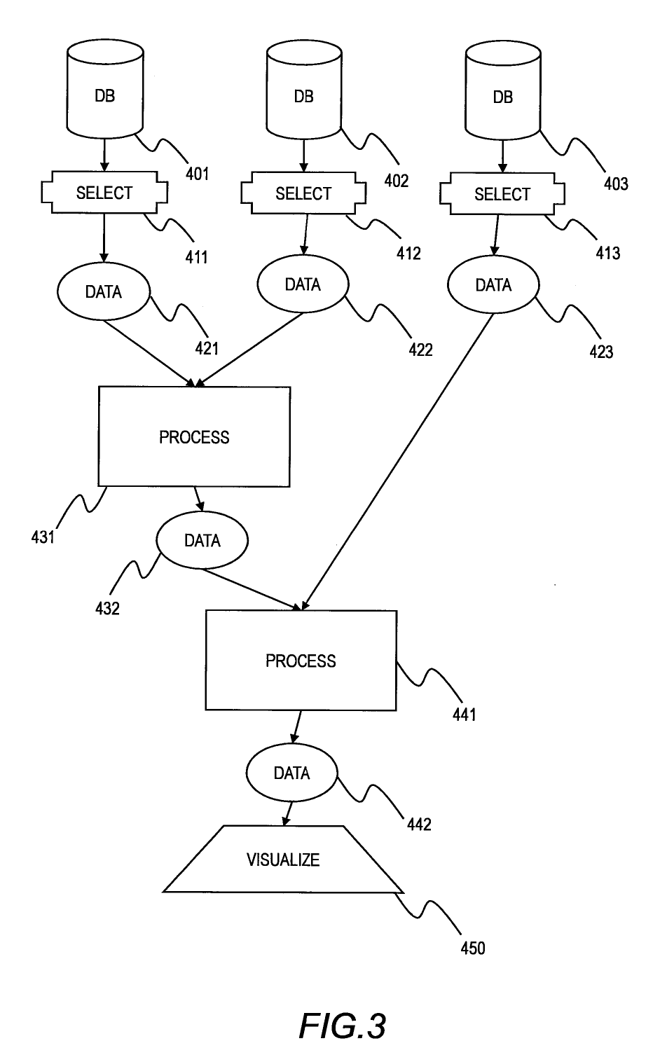

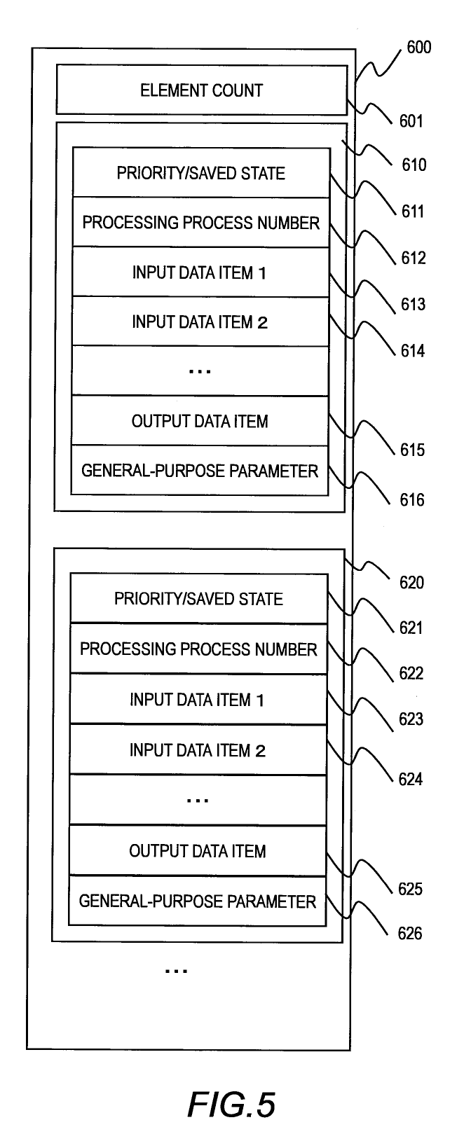

A data analysis to be an analysis task is expressed as a flow (data analysis flow) represented by a tree structure depicted in FIG. 3. FIG. 5 illustrates a data structure 600 for retaining the data analysis flow inside a computer (analysis server PC 210). In FIG. 5, the tree structure is expressed as a list of the node structures 610, 620, and so forth. An element count 601 is described in a memory area of the main memory as a numerical value for managing a total number of node structures. The structure 610 of a data analysis node includes management data 611 indicating a priority and a saved state at a time of creation, a processing process number 612 indicating an ID number of a processing process, a list of the ID numbers of input data items (child nodes) 613 and 614, an ID number of output data item (parent node) 615, and an area for storing a general-purpose parameter 616 according to contents of another analysis. The processing process number 612 is the ID number for calling the program corresponding to the contents of the processing from a predetermined location on the external storage device 307.

Further, the ID numbers of the data items 613 through 615 each represent a data area for describing one or a plurality of (a) a local pointer indicating another structure such as the structure 620 within the data analysis flow, (b) an ID number indicating a database number of one of DBs 401 through 403 illustrated in FIG. 3 to be referenced, and (c) an ID number of a management table within the cache DB 241. Further, the general-purpose parameter 616 represents an area for describing a condition for narrowing down the DB, an adjustment parameter for an analysis processing algorithm, or the like.

(Input Method of Analysis Task)

The scheduler program 2101 executed by the analysis server PC 210 receives tasks of the data analysis requested by the client PC 201 in the form of the data structure 600, and executes the tasks in order according to a numerical value of the priority added to the management data 611. In this embodiment, the analysis is performed according to the script that is explicitly input by the user 200 on the client PC 201 through the analysis processing input program 2010.

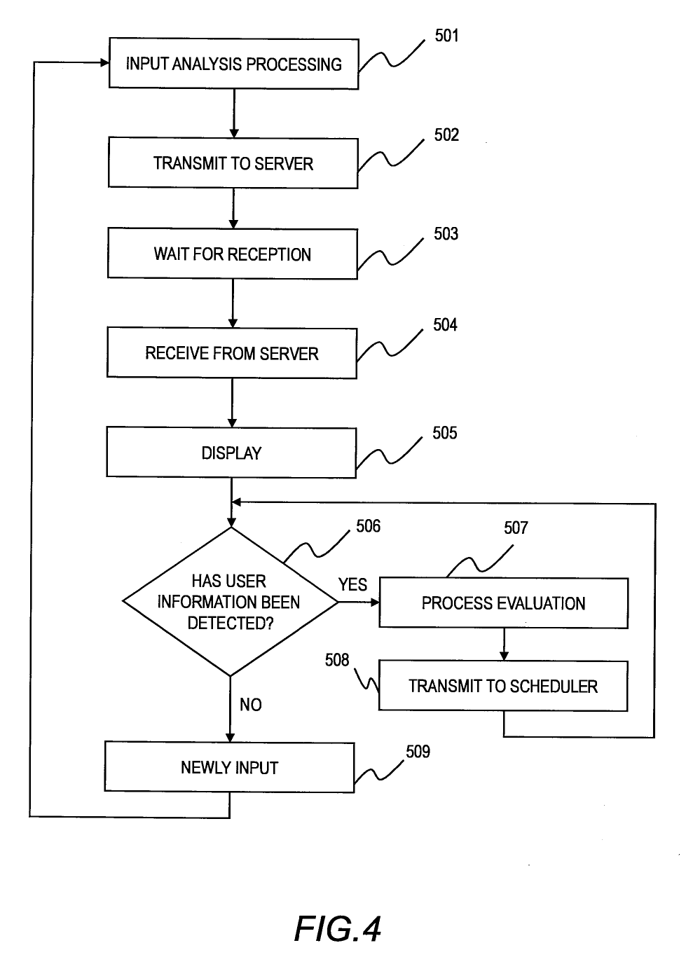

FIG. 4 is a flowchart illustrating the process for a case where the analysis is executed by the user explicitly inputting the contents of the data analysis through the analysis processing input program 2010 of the client PC 201.

Step 501 is a step of defining data subjected to a processing flow by the client PC 201. In this step, the user 200 inputs a graph structure illustrated in FIG. 3 through an interface of an information input program (not shown) provided by the client PC 201.

Employed for this input work is an input technique such as a CUI for expressing the tree structure and the ID numbers by using characters and symbols or a GUI that allows expression/input thereof in the form of graphics. As the input technique, a technique implemented in an existing information analysis device may be used (the input technique for the tree structure data includes a definition using a parenthesized expression as in the description such as Lisp or an interactive connection technique using the GUI, both of which are widely-known general methodologies for computers but do not include novelty of this embodiment, and hence details of its procedure are omitted).

Illustrated in the example of FIG. 3 is the data analysis flow of the tree structure in which data items 421 through 423 are extracted from the DBs 401 through 403 by data extraction modules 411 through 413, the data items 421 and 422 are subjected to a processing by a processing process 431 to output a data item 432, the data items 423 and 432 are processed by a processing process 441 to output a data item 442, and the data item 442 is displayed onto the client PC 201 by a visualization module 450. It should be noted that the data items 421 through 423 and 432 that have been generated midway through the processings become the intermediate data, and are retained in the cache DB 241 as described later.

(Transmission to Server)

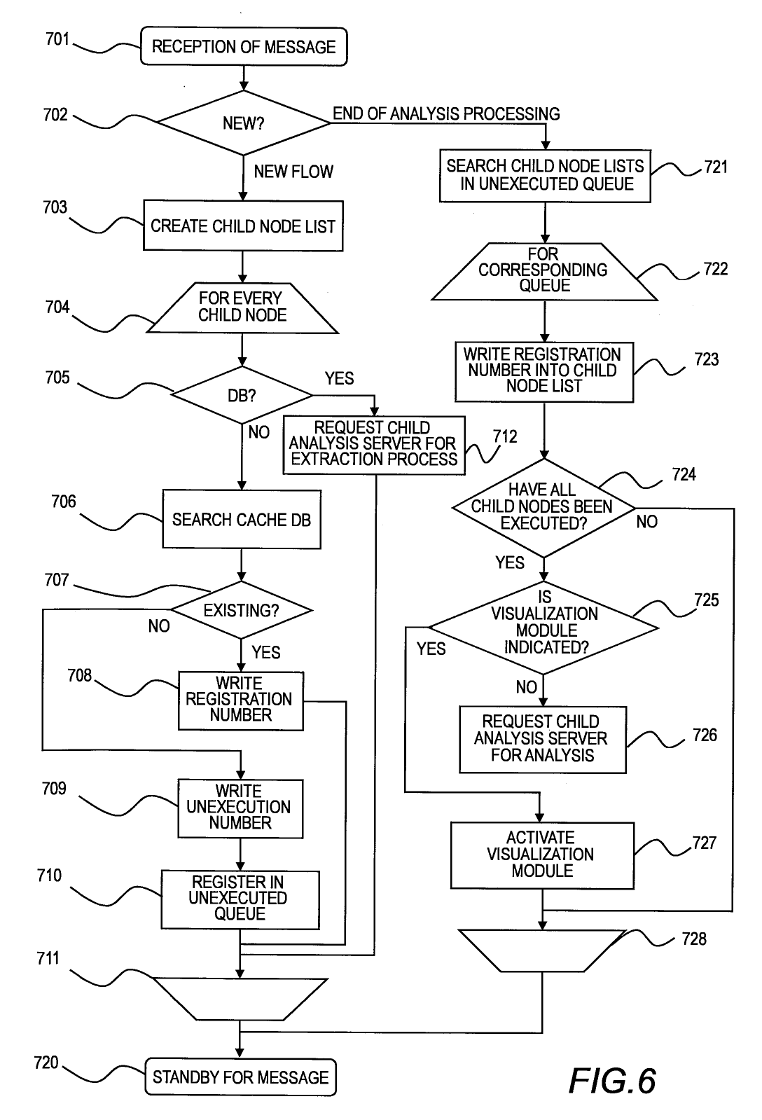

In Step 502, structure data of the data analysis flow is transferred to the analysis server PC 210, this process is brought to a standby state while waiting for a result of the processing performed by the analysis server PC 210 (Step 503). A processing performed by the analysis server PC 210 during the standby state is described later by using the flowchart of FIG. 6.

(End of Analysis Process)

If the analysis processing performed by all the components other than the visualization module (denoted by reference numeral 450 of FIG. 3 and reference numeral 2011 of FIG. 19) is brought to an end, the analysis result is transmitted from the analysis server PC 210 to the client PC 201. The client PC 201 receives the analysis result (504), and activates the visualization module (analysis result presenting program 2011) by using the received data as an input.

(Configuration of Visualization Module)

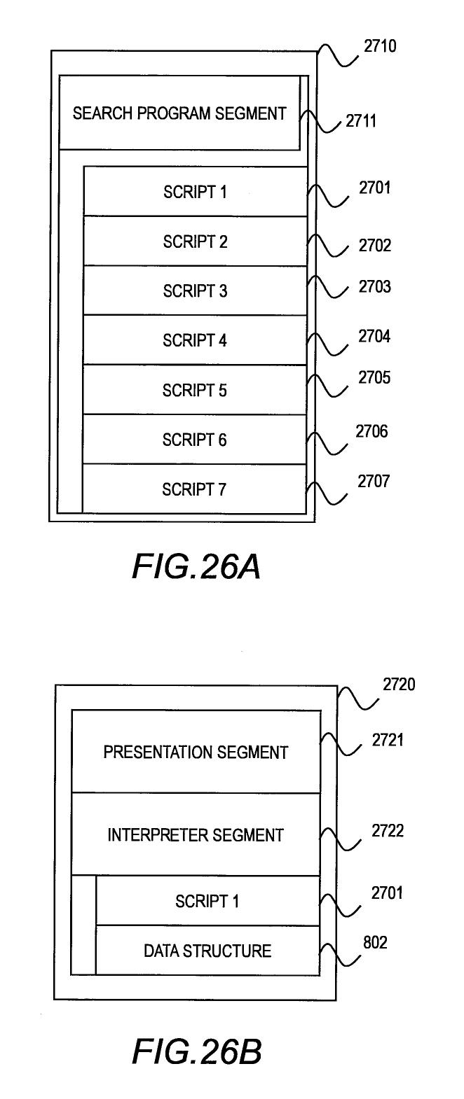

FIGS. 26A and 26B illustrate an example of an implementation that constitutes the visualization module. The visualization module is realized as the analysis result presenting program 2011 on the analysis server PC 210 and the client PC 201 that are general-purpose computer devices as illustrated in FIG. 2. The visualization module is the analysis result presenting program 2011, which is constituted of two parts, in other words, as illustrated in FIGS. 26A and 26B, a display content DB 2710 deployed on the analysis server PC 210 and a display viewer 2720 being a program deployed on the client PC 201.

The display content DB 2710 on the analysis server PC 210 is a database that accumulates scripts that describes details of image processings. The display content DB 2710 has a function of receiving a character string or an ID number that specifies one of the scripts and data accumulated in a predetermined format, searching the database of character string codes 2701 through 2707 of the script by a search program segment 2711 to call a specified code 2701 therefrom, and transmitting the called code 2701 of the source character string and a data structure 802 of FIG. 26B together to the display viewer 2720 on the client PC 201. Hereinafter, a combination of this script code 2701 and the data structure 802 is called “display contents”.

The display viewer 2720 includes a script segment (display contents) 2701 and 802 for describing picture display contents, an interpreter segment 2722 for interpreting a procedure indicated by the script, and a presentation segment 2721 for displaying a result of interactively executing a procedure result onto the screen. The interpreter segment 2722 sequentially executes the script, reads the data structure 802 according to the technique specified by the script, and executes a program of the presentation segment 2721 to perform display as image information onto the display device 203. As a general example, such interpretation of the display script and such a display system can be realized by using a dynamic interpretation mechanism of Java (registered trademark) Script for an Internet browser or other such mechanism.

(Execution of Visualization Module)

The visualization module generates a static image, display contents that can be controlled interactively, and the like, and transfers data thereof to the client PC 201. The display viewer 2720 on the client PC 201 presents the data onto the screen, and stands by or receives an interactive input.

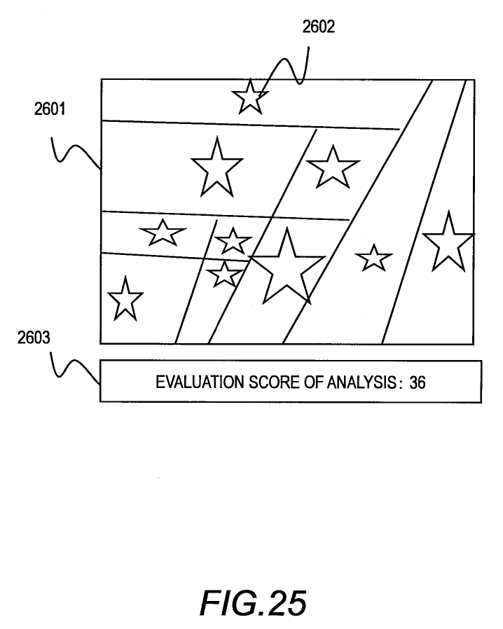

FIG. 25 illustrates an example of a display image generated by the visualization module. Superimposed on a map 2601 are the contents of data obtained by analyzing division areas, which are expressed as graphics accompanied by icons 2602 as illustrated in FIG. 25, and the data on the analysis result is represented as the size and color of a spot. Further, in this case, according to an instruction from the interface device 202, each of the parts of the map is displayed by being interactively enlarged/reduced.

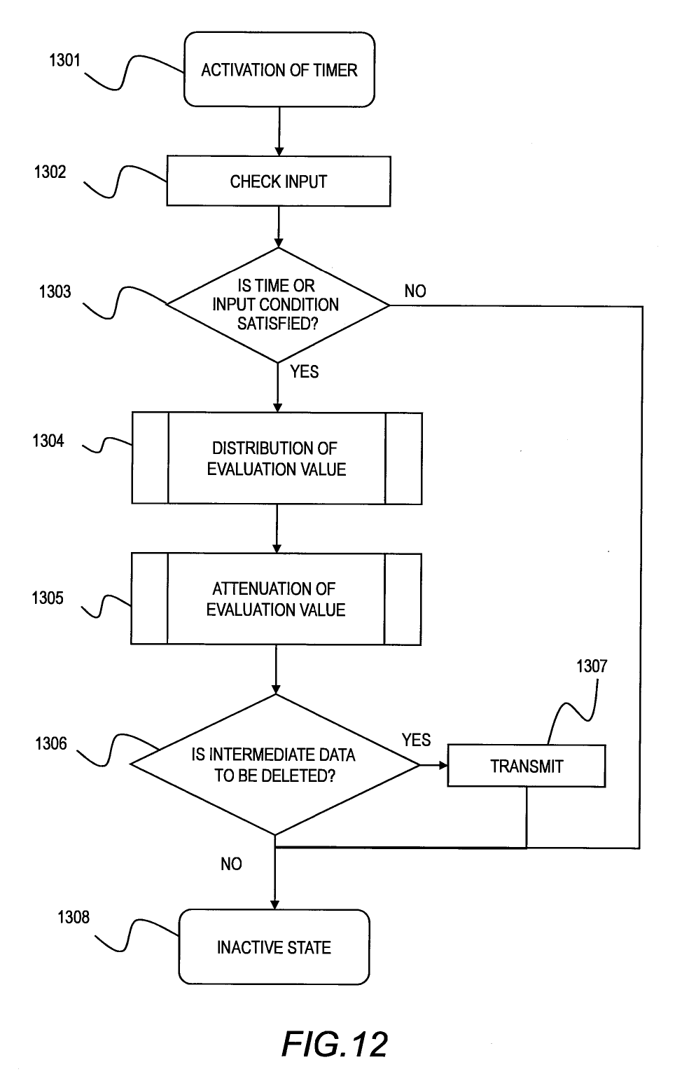

At the end of this display and browsing work, the evaluation result input program 2012 presents a numerical value input screen 2603 of FIG. 25 to the user 200, and prompts an input of an evaluation value with regard to the analysis result (Steps 506 and 507). If the evaluation value is input, the value is transmitted to the scheduler program 2101 of the analysis server PC 210, and is used for management of the intermediate data saved in the cache DB 241 (Step 508). A management procedure for the intermediate data is described later by using the flowchart of FIG. 12.

(Analysis Processing Server)

The flowchart of FIG. 6 indicates processing steps performed by the analysis server PC 210.

The analysis server PC 210 retains a queue for registering an analysis flow to be an analysis subject in the main memory 306. Hereinafter, the queue is referred to as “unexecuted queue”. In an initial state, the analysis server PC 210 is standing by, ready to receive the structure data and an analysis processing start message (Step 701). When a message is received, if the message is a new analysis flow, the analysis server PC 210 executes the processing contents of Steps 703 through 711, and if the message is a notification of the end of a partial analysis transmitted from the child analysis server PCs 221 through 223, executes Steps 712 through 719 (Step 702).

(Case of New Analysis Flow)

Description is made of Steps 703 through 711 by assuming that a behavior exhibited in the case where the message received in Step 701 is a message of the new analysis flow transmitted from the client PC 201 is the analysis of the tree structure in which a root for the analysis is expressed by a pair of data structures 610. The analysis server PC 210 creates the structure data by making a list of the input data items 613 and 614 along with the ID of a parent analysis (processing process number 612) of the tree structure. Hereinafter, the structure data is referred to as “child node list” (Step 703).

The analysis server PC 210 selects the input data items 613 and 614 (child nodes) from the child node list one by one (Step 704), and examines whether or not the node is a data extraction process involving a direct reference to the DBs 231 through 233. If so, the analysis server PC 210 requests the child analysis server PCs 221 through 223 for the data extraction process (Step 712).

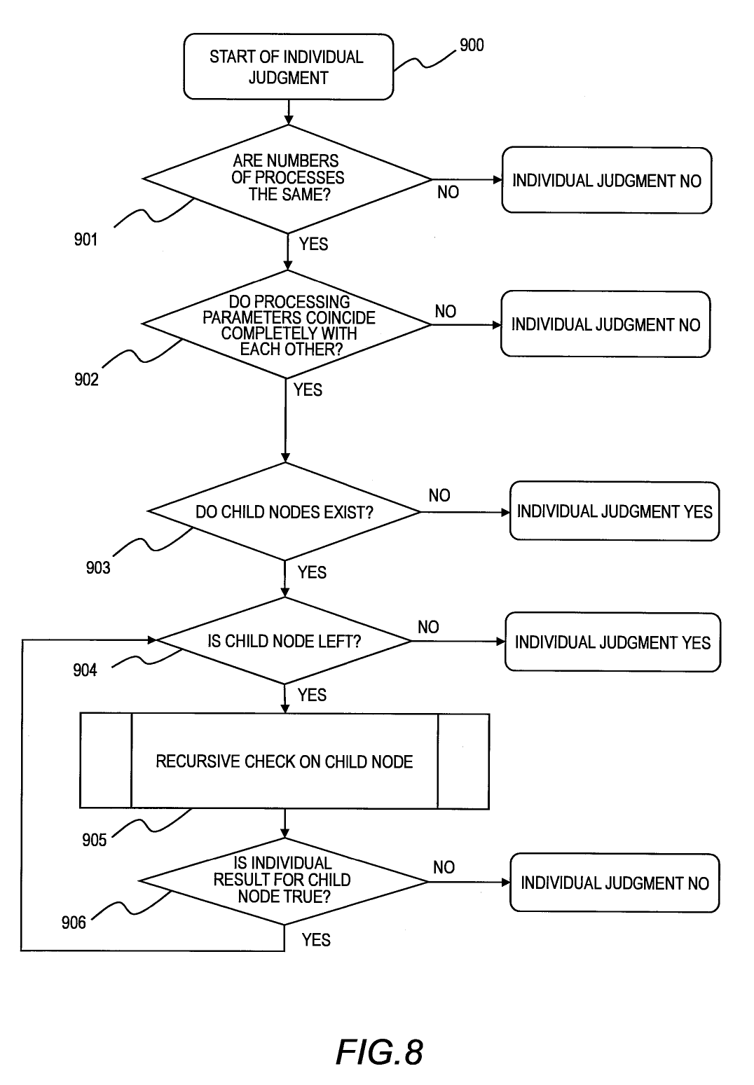

In a case other than the data extraction process (No in Step 705), the analysis server PC 210 performs a processing of Steps 706 through 710 with regard to the corresponding analysis contents. First, the analysis server PC 210 requests the cache DB 241 to judge whether or not the intermediate data has already been registered in the cache DB 241. To that end, the analysis server PC 210 makes a list of all the data items that can be traced by the data structure 600, creates a message of a request to search for similar data, and transfers the message to the cache DB 241 (Step 706). Hereinafter, the above-mentioned list is referred to as “partial analysis flow processing script”. The cache data search program 2411 of the cache DB 241 performs a conditional comparison between the partial analysis flow processing script transmitted from the analysis server PC 210 and the data registered in the table of the cache data management program 2412. A processing for the conditional comparison performed by the cache DB 241 is performed later according to the flowchart of FIG. 8. After the end of the conditional comparison, data that combines judgment regarding reusability and a registration number is transmitted from the cache DB 241 (Step 707).

If there already exists a corresponding reusable data in the cache DB 241, the analysis server PC 210 writes the number (registration number) indicating the saved location of the intermediate data, which has been transmitted from the cache DB 241, into the child node list, and simultaneously turns on an executed flag for the child node (Step 708).

If there exists no corresponding reusable data (intermediate data) in the cache DB 241, the analysis server PC 210 writes the number (unprocessed) indicating the saved location of the intermediate data, which has been transmitted from the cache DB 241, into the child node list, and simultaneously turns off the executed flag for the child node (Step 709). A partial tree the root of which is the child node is extracted from the analysis flow, a new analysis flow is created, and recursive registration (Step 710) is called as the new analysis flow and performed on the scheduler program 2101 itself.

(Case of End of Partial Analysis)

Description is made of a processing performed in the case where the message received in Step 701 is a message of the end of the partial analysis transmitted from the child analysis server PCs 221 through 223. Information transmitted from the child analysis server PCs 221 through 223 includes the number indicating the saved location of the intermediate data within the cache DB 241. The analysis server PC 210 searches for this number from all the child node lists registered in the unexecuted queue, and performs Steps 723 through 727 on the child node list including the number for the child node (Steps 721 and 722).

First, the analysis server PC 210 turns on the executed flag for the child node (Step 723). Subsequently, the analysis server PC 210 examines whether or not all the elements included in the child node list have been executed (Step 724). If all the elements included in the child node list have been executed, the analysis server PC 210 judges which of the visualization module 2011 and the data analysis module 2211 the ID of the parent analysis indicates (Step 725). If the ID of the parent analysis indicates the data analysis module 2211, the analysis server PC 210 requests the child analysis server PCs 221 through 223 to execute the program of the data analysis module 2211 (Step 726). Meanwhile, if the ID of the parent analysis indicates the visualization module 2011, the analysis server PC 210 reads the data on the analysis result from the cache DB 241, and requests the client PC 201 to execute the visualization module 2011 (Step 727).

(Standby State)

At a time point when the above-mentioned processing ends, the analysis server PC 210 is brought to a message standby state again in Step 720, and waits for the next reception.

(Judgment of Identity)

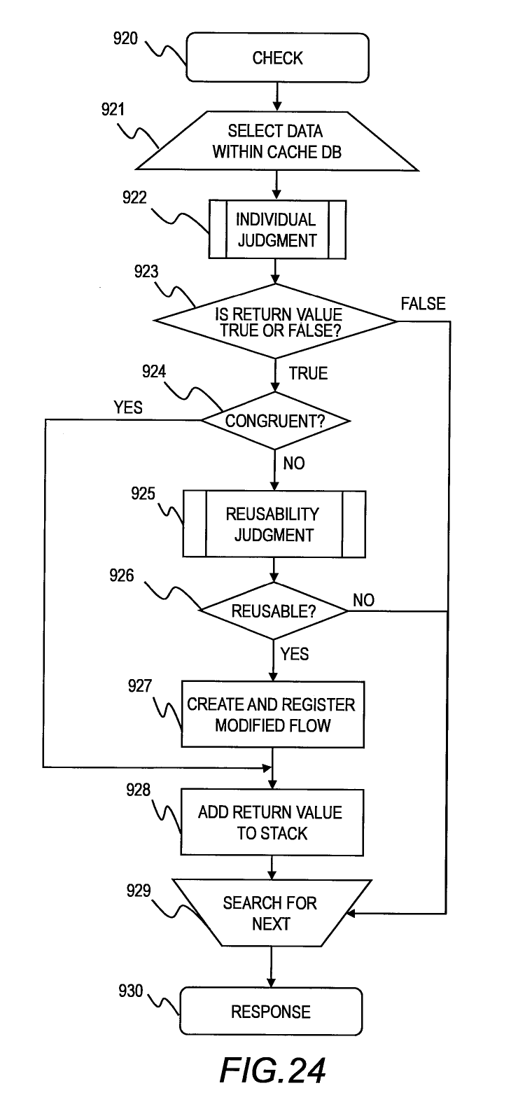

A series of routines for judging a congruence or similarity between the analysis data (intermediate data) registered in the cache DB 241 and the partial analysis flow processing script is illustrated in the flowcharts of FIG. 8 and FIG. 24. The judgment processing is constituted of two routines, in other words, an individual judgment routine of Steps 900 through 906 illustrated in FIG. 8 for recursively checking coincidences on an individual analysis flow and an overall routine illustrated in FIG. 24 for carrying out the individual judgment routine on the whole intermediate data within the cache DB 241.

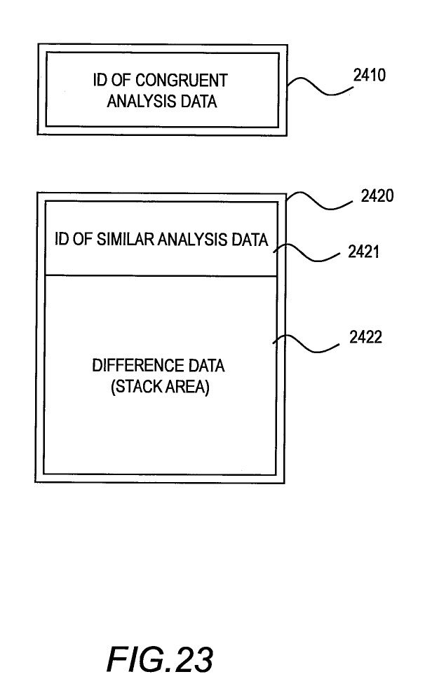

The overall routine compares a target analysis flow and an analysis flow saved in the intermediate data retained in the cache DB 241, judges (i) a case (congruence) where completely the same analysis flow exists or (ii) a case (similarity) where there exists an analysis flow that is similar but has a different parameter of a range for narrowing down data, and if there exists the intermediate data corresponding to each of (i) and (ii), stores data into a structure 2410 or 2420 illustrated in FIG. 23 and returns a list of the structures as a return value.

Further, the individual judgment routine compares the target analysis flow and the analysis flow saved in the intermediate data, and returns the value “True” if the tree structures are similar to each other while returning the value “False” if the tree structures are different from each other. Further, if the parameters of the corresponding nodes in the tree structures do not coincide with each other, difference information between the nodes is added to a stack and returned.

In Step 901 of FIG. 8, the analysis server PC 210 compares a program ID number of an element analysis processing at the corresponding node of the data analysis processing on the analysis server PC 210 with a program ID number of an element analysis processing at the corresponding node of the data analysis processing on the cache DB 241. If the comparison results in the difference (“Individual judgment: No” in FIG. 8), the processing for recursive judgment is aborted by assuming that a similar analysis processing result cannot be found, and the value “False” is returned as the return value.

In Step 902, the analysis server PC 210 compares the information stored in the general-purpose parameter 616 between the element analysis processing at the corresponding node of the data analysis processing on the analysis server PC 210 and the element analysis processing at the corresponding node of the data analysis processing on the cache DB 241. If the comparison results in the difference (“Individual judgment: No” in FIG. 8), the value “False” is returned as the return value by assuming that the same analysis processing result cannot be found.

In Step 903, the analysis server PC 210 checks whether or not there exists a child node (in other words, input data item 613 or 614) in the corresponding element analysis processing node of the data analysis processing. However, if the input required by the element analysis processing is only the ID indicating the DB, the analysis server PC 210 examines the ID number indicating the table of the DB, and returns the value “False” if the ID numbers are different. If the ID numbers are the same, the value “True” is returned by assuming that the same processing is performed as the element analysis processing.

In Steps 904 through 906, the analysis server PC 210 sequentially searches for the child nodes for the element analysis processing of the data analysis processing on the cache DB 241 (Step 904), and in order to examine the identity between the child node and the element analysis processing existing in the corresponding location within the data analysis processing on the cache DB 241, performs a recursive check by executing the same routine starting at Step 900 on those data (Step 905). If the recursive check on the child node results in false (No in Step 906), the value “False” is returned as the return value. If the recursive check on all the child nodes never results in false even when the processing for the recursive check ends (Yes in Step 906 and No in Step 904), the value “True” is returned.

If the results coincide with each other for every child node as a result of the check on the above-mentioned recursive flow, the nodes of the tree structure are regarded as similar in the basic configuration. In addition, if the stack is empty, the nodes of the tree structure are regarded as congruent.

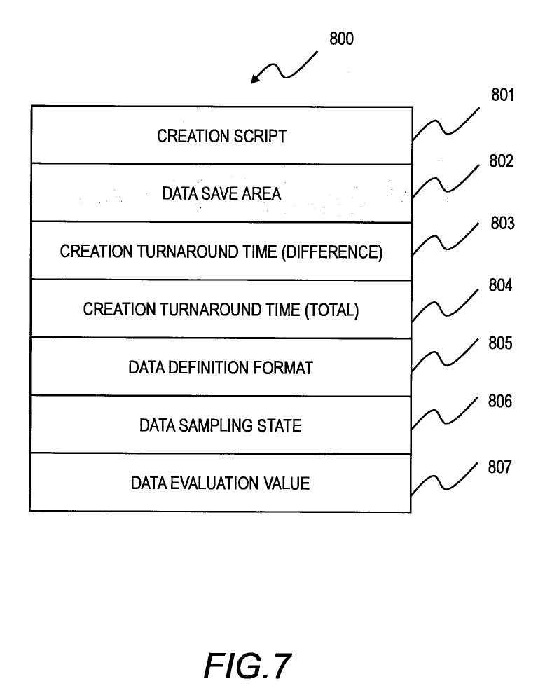

The cache DB 241 is searched for the intermediate data by repetition of the above-mentioned individual judgment routine. Meanwhile, upon reception of the analysis flow to be a task, the cache DB 241 starts the processing of FIG. 24 (Step 920). The cache DB 241 selects the intermediate data registered therein (Step 921), and performs a comparison with a creation script 801 saved in the management table, the structure of which is illustrated in FIG. 7, according to the above-mentioned technique (Step 922).

If the return value is “False” as a result of the above-mentioned comparison, there is no similarity between the data items, and hence the next data item is retrieved (Step 923). Meanwhile, if the return value is “True” as a result of the above-mentioned comparison, the cache DB 241 references the stack state at a time of the end of the recursive flow (Step 924). If the saved data and the processing of the analysis flow of the search target are congruent, the stack does not contain information at all. In this case, the intermediate data can be fully reused, the cache DB 241 describes pointer information (ID) indicating the cache DB 241 into the structure 2410 of the ID of the congruent analysis data, and adds the structure 2410 to the list (Step 928).

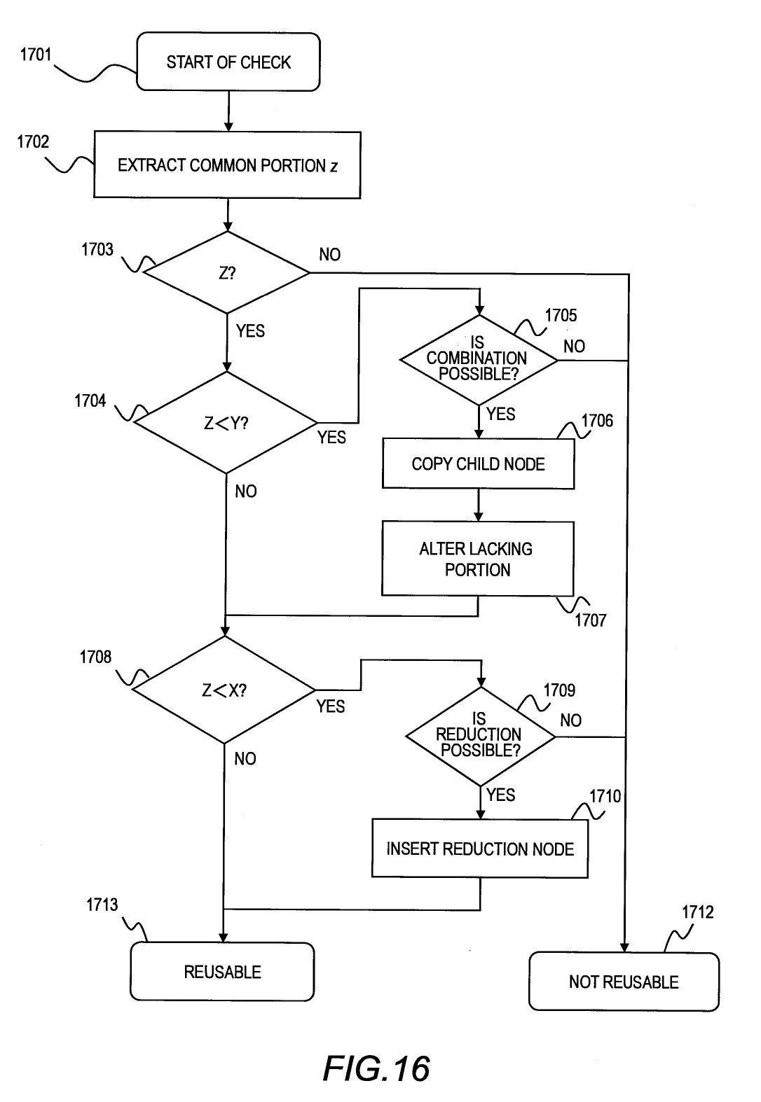

Further, if the data item saved in the cache DB 241 is similar but different, data indicating the difference is contained in the stack. In this case, the cache DB 241 performs a check on the similar data item as to whether or not a lacking portion/modified portion of the data can be compensated for by using a program for data synthesis (described later) associated with each element analysis processing (procedure for contents of the check described later with reference to FIG. 16) (Step 925). The cache DB 241 judges whether or not the similar data item is reusable based on the return value obtained from the flowchart of FIG. 16 (Step 926), and if an output result can be created by compensating for the lacking portion of the data, creates a processing for creating the lacking data portion and a processing for synthesizing the data as an analysis flow processing script and newly registers the analysis flow processing script as a processing to be performed by the analysis server PC 210 (Step 927).

Subsequently, the cache DB 241 creates the structure 2420 of FIG. 23 by storing the pointer information (ID) indicating the cache DB 241 as an ID 2421 of a similar analysis data and the difference information as difference data 2422, and adds the structure 2420 to the list (Step 928). If judging that all the checks have ended (Step 929), the cache DB 241 returns search results for the intermediate data as a list to the analysis server PC 210 (Step 930).

(Processing by Child Analysis Server)

The processing of each element analysis requested by the analysis server PC 210 is executed by the child analysis server PCs 221 through 223.

The data analysis module 2211 for the analysis processing includes two kinds of modules, in other words, a data extraction module and a data analysis module. The data extraction module extracts, from the DB, only data that has the ID indicating the table of the DB as the input data items 613 of FIG. 5 and that is necessary under the constraint of the general-purpose parameter 616. The data analysis module 2102 of the analysis server PC 210 receives the intermediate data output by other modules indicated by the IDs of the input data items 613 and 614 as an input, and performs the analysis processing under the constraint of the general-purpose parameter 616.

Further, in order to reuse intermediate output results (intermediate data) accumulated in the cache DB 241 and perform a processing on the new data, each of the data analysis modules 2211 is additionally provided with a synthesis computation processing and a reduction computation processing. Description is made later of contents of a synthesis/reduction processing.

Various calculation processings generally used in the information processing are implemented in the program of the data analysis module 2211. In this embodiment, it is assumed that modules of analysis techniques for obtaining moving-average filtering of time-series data, a covariance matrix on a data element basis, clustering of the data element, a distance function between classes, and the like are implemented as representative examples of the processing performed by the data analysis module 2211.

In this embodiment, those data analysis modules 2211 receive grouped data and a processing parameter as an input. Each of the data analysis modules 2211 has unique definitions of a data type and the number of input/output data items, and checks compatibility of the data type of a variable before execution of a module processing. Examples of the data type for the input/output include time-series data, time-series data segmented on a unit time basis, and a state class obtained by clustering.

Those programs of the data analysis modules 2211 are previously retained in a ROM within the child analysis server PCs 221 through 223 or a storage area (external storage device 307). Information for generating an instance of the program of the data analysis module 2211 can be expressed by the above-mentioned program module for performing an element analysis process, data to be subjected to the processing, and the tree structure indicating a connection relationship therebetween.

Upon reception of a message described in the data analysis node structure 610 transmitted from the analysis server PC 210, the child analysis server PCs 221 through 223 generate the instances of those element analysis processes.

In an execution instance of each program module (data analysis module 2211), the ID number indicating a destination to which the data is saved within the cache DB 241 is used as the input data items, the output data, and the parameter at a time of the execution, and used for the input/output of the data at the time of the execution.

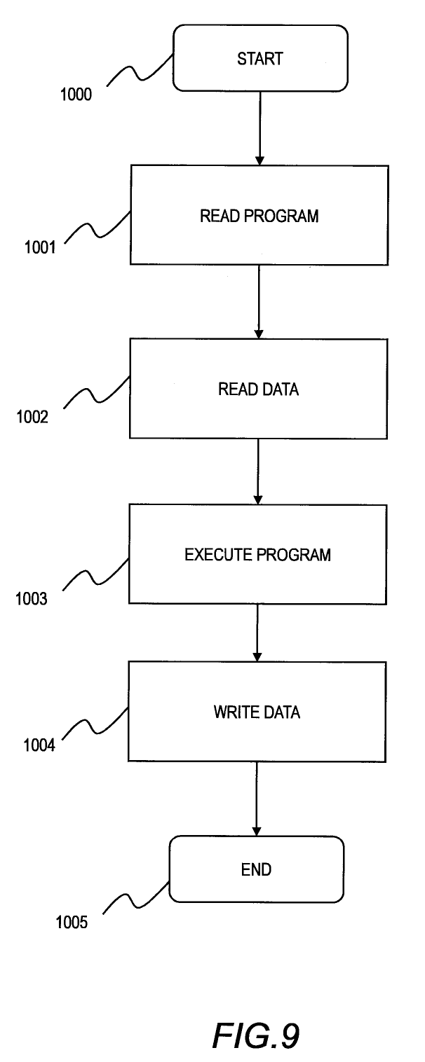

The flowchart of FIG. 9 indicates a series of procedures for executing an analysis processing instance by the child analysis server PCs 221 through 223.

On the child analysis server PCs 221 through 223, a scheduler is standing by for the processing contents transmitted from the analysis server PC 210 (Step 1000). Upon reception of the processing contents, the child analysis server PCs 221 through 223 read a program indicated by the processing process number 612 of the data analysis node structure 610 from the ROM or the storage area (Step 1001), and simultaneously read the input data items 613 and 614 separately from the cache DB 241 (Step 1002). Further, the child analysis server PCs 221 through 223 simultaneously read management table information 800 for managing the input data items, which is illustrated in FIG. 7, from the cache DB 241.

In Step 1003, the child analysis server PCs 221 through 223 execute the read program by applying the program to the read data. Calculation results thereof are saved to the cache DB 241 (Step 1004). Further, the child analysis server PCs 221 through 223 input the time taken for this processing as a creation turnaround time (difference) into a creation turnaround time (difference) 803 in the management table information 800 of the cache DB 241 illustrated in FIG. 7, saves a value obtained by adding a turnaround time of this process to a total value of a creation turnaround time (total) 804 that has been registered as turnaround times of the input data items into the creation turnaround time (total) 804, and transmits a message of the end of the process to the analysis server PC 210.

(With Regard to Combinability/Separability of Inputs of Data Analysis Program)

As one of characteristic points of this embodiment, such a function exists as to return information indicating whether or not the combination (synthesis) or separation between newly input data items and the existing processing results is possible against a change such as an increase/reduction of the input data items if there exists output data (analysis result) that has undergone calculation, and with regard to the processing capable of the synthesis/separation, an algorithm therefor is also described.

The case where the combination of the input data items is possible represents a case where a function f of Formula (1) can be defined by using an output result g of the data analysis module 2211.

f1(g(a)+g(b))=g(a+b) (1)

where g is a function indicating the processing of the program of each data analysis module 2211, and the outputs of input sets a and b are described as g(a) and g(b), respectively. A function f1 is a function for executing the processing with the processing results g(a) and g(b) being its inputs. A union of the input sets a and b is set as a+b.

The class of the data analysis module 2211 has a member function for returning combinability and an interface to a function for performing a combination processing. The member function is a static function in which, in a case where there are two input data sets and their respective output results, the value “True” is returned if the same result as a result obtained by processing the input data sets based on the synthesis thereof can be returned by processing the two output results, and if not, the value “False” is returned. In the case of “True”, a program that realizes the function f for performing the combination processing is defined.

Simple examples of a processing capable of such synthesis of the data may include a calculation processing for returning the number, an average, and a dispersion of data items.

Meanwhile, the case where the reduction of the input data item is possible represents a case where a function f2 of Formula (2) can be defined by using the output result g of the data analysis module 2211.

f2(g(a+b),a)=g(a) (2)

where g is a function indicating the processing of the program of each data analysis module 2211, the output of the input set a is described as g(a), and the union of the input sets a and b is set as a+b. In this case, the function f2 represents a function that works with the processing result g(a+b) and a range of the subset a as its inputs.

The class of the data analysis module 2211 has a member function for returning separability and an interface to a function for performing a separation processing. The member function is a static function in which, in a case where there is an input data set and its output result, the value “True” is returned if it is possible to obtain a result by performing the processing with the subset of the input data set as the input can be obtained, and if not, the value “False” is returned. In the case of “True”, the function f for performing the separation processing is defined.

Examples of such a processing may include a filter processing such as a moving average for which locality is guaranteed in the data processing.

Further, with regard to the function capable of the synthesis of the input data items, it is possible to perform deletion on a group basis not only by retaining the entire output results as the intermediate data but also by retaining each output result obtained by individually processing a group of each partial set as the intermediate data.

(Routine for Synthesizing Data/creating New Flow)

Further, each data analysis module 2211 has an algorithm for judging whether or not the calculation cost of the new data can be omitted by reusing the result (intermediate data) output in the past. FIG. 16 illustrates the above-mentioned algorithm.

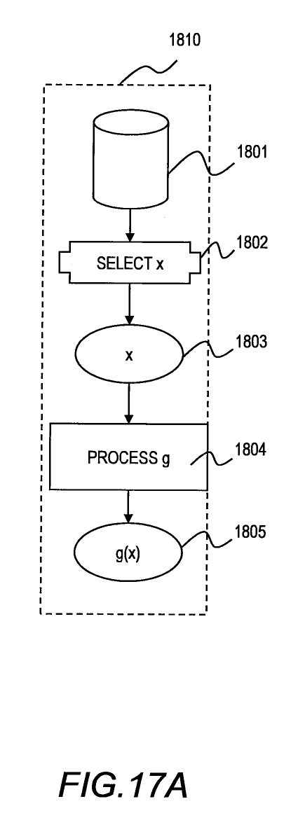

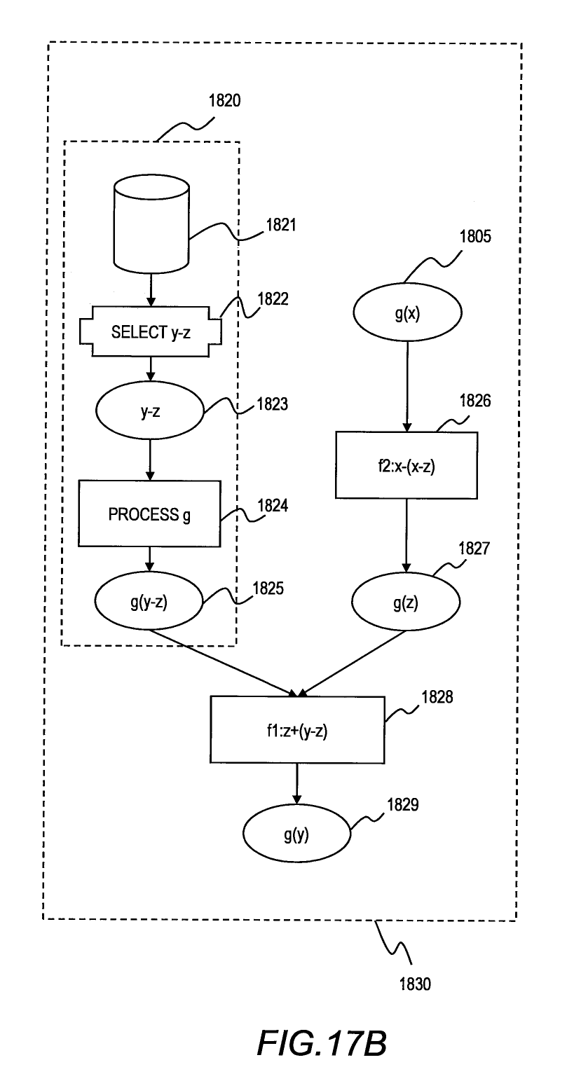

An intermediate data item g(x) obtained by processing an input data item x already exists in the cache DB 241, and hence the data analysis module 2211 has an object to perform a processing to obtain an output g(y) from an input data item y this time. FIGS. 17A and 17B are schematic diagrams of new tree structure data created as a result of this processing.

In FIG. 16, in order to examine an inclusion relationship between the input data item x of the existing intermediate data and the target input data item y for each input data items, a common portion z (intersection) between the input data item x and the input data item y is extracted (Steps 1701 and 1702).

If there is no common portion z between the input data item x and the input data item y, the value “False” is returned by assuming that the reuse is impossible (Steps 1703 and 1712).

Meanwhile, if the common portion z exists with the input data item y including data other than the common portion z (Step 1704), the above-mentioned member function is used to query the module as to whether or not the combination processing f1 for the input data items is possible, and if impossible, the value “False” is returned by assuming that the reuse is impossible (Steps 1705 and 1712).

If the combination processing f1 for the input data items is possible as a result of the check, a data flow (script) for the intermediate result obtained by performing the creation of the input data item x is copied from the area of the creation script 801 of the structure data saved in the cache DB 241 (Step 1706).

Hereinafter, for the purpose of description, a processing for deriving the data item g(x) is expressed as a processing 1810 in FIG. 17A. An extraction process 1802 for the target data has a parameter rewritten from the input data item x to (input data item y)-(common portion z) (processing 1822), and is converted into a flow for deriving a data item g(y-z) (Step 1707).

If the input data item x includes a data other than the common portion z (Step 1708), the above-mentioned member function is used to query the module as to whether or not the reduction processing f2 for the input data item is possible. If impossible, the value “False” is returned by assuming that the reuse is impossible (Steps 1709 and 1712).

If the reduction processing f2 for the input data item is possible, the processing of the function f2 is used based on the data item g(x) to describe a processing 1826 for reducing the element corresponding to the area z-x in the analysis flow (Step 1710). Further, the data item g(z) thus created and a processing script 1820 created earlier in Step 1707 are coupled by a synthesis processing 1828 of the function f1, and a new tree structure is created (Step 1713). As illustrated in FIG. 17B, the existing processing 1810 illustrated in FIG. 17A is replaced by a new tree structure 1830 using the intermediate data created in the above-mentioned steps.

(Module for Extracting Data from DB)

In FIG. 3, the data extraction modules 411 through 413 have a function of extracting data satisfying the constraint indicated by the input parameter from the DBs 231 through 233 corresponding to the DBs 401 through 403 of FIG. 3, and reading the data.

Typical examples of a constraint parameter received by the data extraction modules 411 through 413 include a process having given conditional expressions of a given time range, a given spatial range, and description data contents, and extracting all the corresponding data items from the DB and listing the data items as an output. A program description method for such a conditional processing and a procedure for the extraction can be realized by using a relational database management system (RDBMS) and an implementation that conforms to an existing data processing language such as SQL.

Further, the DBs 231 through 233 similarly hold general information data used for assisting the analysis processing, which are extracted/read for use according to the need for an algorithm for the analysis processing or an algorithm for the visualization processing. Typical examples thereof include: an analysis processing algorithm for examining a correlation with another individual data item after previously registering position coordinates of police stations/substations in each of Japan's prefectures and a Voronoi diagram; and a visualization processing program (analysis result presenting program 2011) for extracting information on a map image corresponding to a given region name. Those script descriptions for indicating the constraints in the extraction from the DBs 231 through 233 are defined in the management data 611 within a format of the structure 610 of FIG. 5.

In this embodiment, it is assumed that the basic configurations of the DBs 231 through 233 for realization thereof conform to a configuration that uses a general-purpose computer and is widely implemented as software of the RDBMS, and that general characteristics thereof are known characteristics.

(Display and Evaluation)

For review of the analysis result, the user 200 operates the client PC 201 to view a display result thereof and perform an interactive operation.

The analysis processing input program 2010 that operates on the client PC 201 presents the user who has viewed the analysis result with a screen for inputting a numerical value, and receives a numerical value via the interface device 202. The user 200 inputs a numerical value (hereinafter, the value is referred to as “evaluation value”) as a serviceability of the analysis result. In order to use the evaluation value as a value of the analysis data, the client PC 201 transfers the ID of the analysis process and the input evaluation value to the scheduler program 2101 operating in the background of the analysis server PC 210.

(Activation of Evaluation Scheduler)

FIG. 12 is a flowchart describing a processing process of the scheduler program 2101 running on the analysis server PC 210. The scheduler program 2101 is activated based on a timer every predetermined time interval to execute Steps 1302 through 1308 (Step 1301).

In Step 1302, the scheduler program 2101 checks whether or not data on the evaluation value for the analysis process has been transmitted from the client PC 201. In a case (1) where a time measured since the previous update exceeds a predetermined value (referred to as “unit attenuating time”) or in a case (2) where an update message for the evaluation value has arrived (Yes in Step 1303), the scheduler program 2101 executes Steps 1304 through 1308. In a case other than the case (1) or (2) (No in Step 1303), the scheduler program 2101 returns to an inactive state (Step 1308).

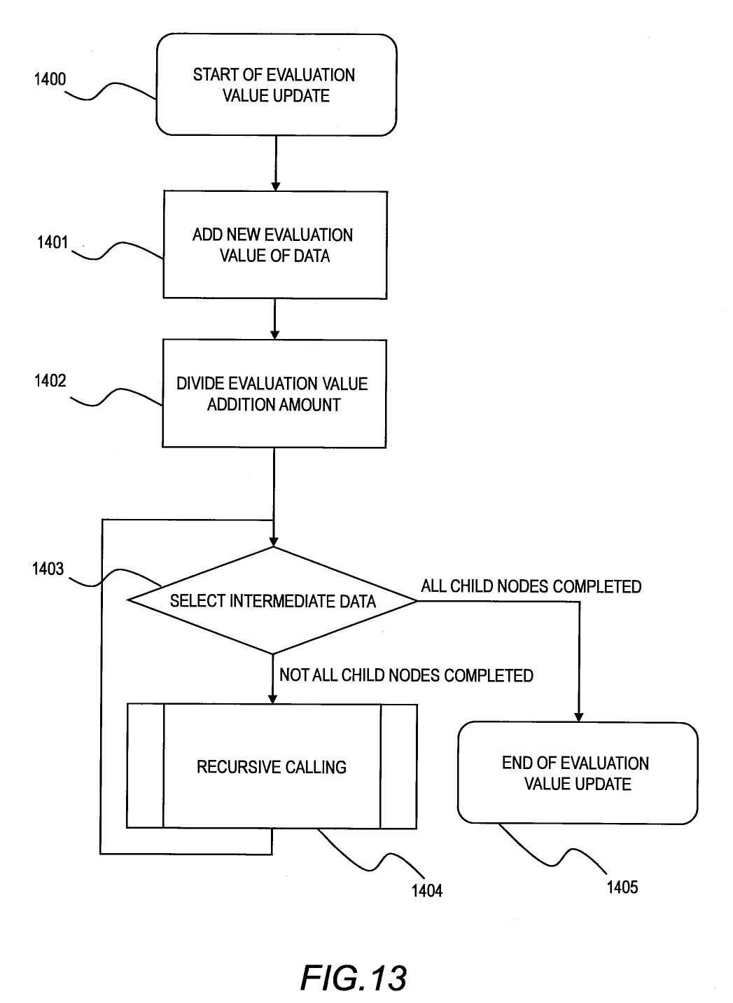

In Step 1304, according to steps (described later) illustrated in the flowchart of FIG. 13, a new evaluation value is redistributed as an evaluation of each of the intermediate data items in the cache DB 241.

In the subsequent Step 1305, the redistributed value of each of the intermediate data items is attenuated by a predetermined amount.

In the subsequent Step 1306, with regard to each of the intermediate data items, the scheduler program 2101 checks whether or not the updated evaluation value is smaller than a threshold value X1 determined by the following Formula (3), and if the evaluation value is smaller than the threshold value, transmits a deletion message for the intermediate data to the cache DB 241 (Step 1307). If the deletion message arrives, the cache DB 241 deletes the information on the corresponding intermediate data item from a storage (external storage device 307).

X1=m1_{—}s×(S_{—}0—S_{—}c)−m1_{—}t×(T_{—}c) (3)

where S_{—}0 is a remaining capacity of the storage of the cache DB 241, S_c is a data size by which the current intermediate data occupies the cache, and T_{—}c is a value of the calculation cost (creation turnaround time (total) 804) taken for the creation of the intermediate data.

After the end of the processing of those steps, the scheduler program 2101 is brought to an inactive state (Step 1308).

According to the above-mentioned processing, the intermediate data of which the evaluation value received from the client PC 201 is less than a threshold value is deleted from the cache DB 241, which allows the cache DB 241 to prevent the amount of the intermediate data stored in the storage (external storage device 307) from becoming excessively large.

(Evaluation Reference Value for Background Activation)

FIG. 13 illustrates a processing in which the scheduler program 2101 on the analysis server PC 210 performs recalculation of the evaluation value of the intermediate data in Step 1304 of FIG. 12 as described above.

The scheduler program 2101 performs the recalculation of the evaluation value for each of the intermediate data items in the cache DB 241 every predetermined time interval. In this case, if a message of the evaluation value has been received from the client PC 201, the scheduler program 2101 distributes the evaluation value to each of the intermediate data items from the evaluation value of the above-mentioned final analysis data according to the following procedure.

In order to calculate a distribution addition amount ED_i of the evaluation value of each of intermediate data items D_i from an evaluation value ED_p of the final analysis data, the scheduler program 2101 performs the following recursive calling with the final analysis data as a caller.

First, if an evaluation value ED_i of intermediate data (or final analysis data) D_i is obtained (Step 1401), the scheduler program 2101 adds the evaluation value ED_i to the evaluation value 807 of the intermediate data within the management table information 800 on the analysis server PC 210. Further, the scheduler program 2101 searches the creation script (structure 610 illustrated in FIG. 5) described in the creation script described in the creation script 801 of the management table information 800 for the input data items D_i (input data items 613 and 614) directly used to derive the data D_i , and divides the evaluation value ED_i of each of the input data items D_i based on the retrieved information by the following Formula (4) (Step 1402).

ED_{—}i=ED_{—}i×{DT_{—}i}/{ΣDT_{—}n}_{—}{n in DJ} (4)

where DT_i is the creation turnaround time (total) 804 taken for obtaining the data D_i which is described in a management log for each of the intermediate data items.

The scheduler program 2101 passes the evaluation value ED_i to the node of the intermediate data, and recursively executes a dividing processing (Step 1404). If the processing is finished for all the child nodes (Step 1403), the procedure returns to the parent node (Step 1405).

According to the above-mentioned steps, the intermediate data that has not been reused for an analysis result given a high evaluation value for a predetermined time period is deleted from the cache DB 241. With regard to a timing for the deletion, the intermediate data having a larger data size is deleted earlier as indicated by Formula (6) described later, and the intermediate data that takes more time for the data creation is given a higher evaluation value as indicated by Formula (7). However, the intermediate data that can be shared by a plurality of analyses is taken into a new analysis process that has been rewritten, and is given a new evaluation value.

As described above, in this embodiment, it is possible to save the intermediate data generated at an intermediate stage of the analysis to the cache DB 241, receive feedback information for the saved data as the evaluation value by the analysis server PC 210, and preferentially delete the intermediate data that has not been given an evaluation value from the cache DB 241 while performing the analysis processing for the similar data on the intermediate data that has received a particularly high evaluation score, which makes it possible to perform automatic management of the intermediate data by a background processing so that the analysis of data to be subjected to a comparison and a derivatively-assumed analysis can be performed at high speed. Accordingly, it is possible to realize a high speed analysis processing using the intermediate data while preventing the area for saving the intermediate data within the cache DB 241 from becoming excessively large.

### SECOND EMBODIMENT

As a second embodiment of this invention, such an implementation is exemplified as to include a mechanism in which, if the user gives a high evaluation value to the analysis result obtained in the first embodiment, data on an analysis similar to the analysis is automatically created. The second embodiment has the same configuration as the first embodiment except that a processing for automatically creating new data on the analysis similar to the previous analysis is added to the first embodiment.

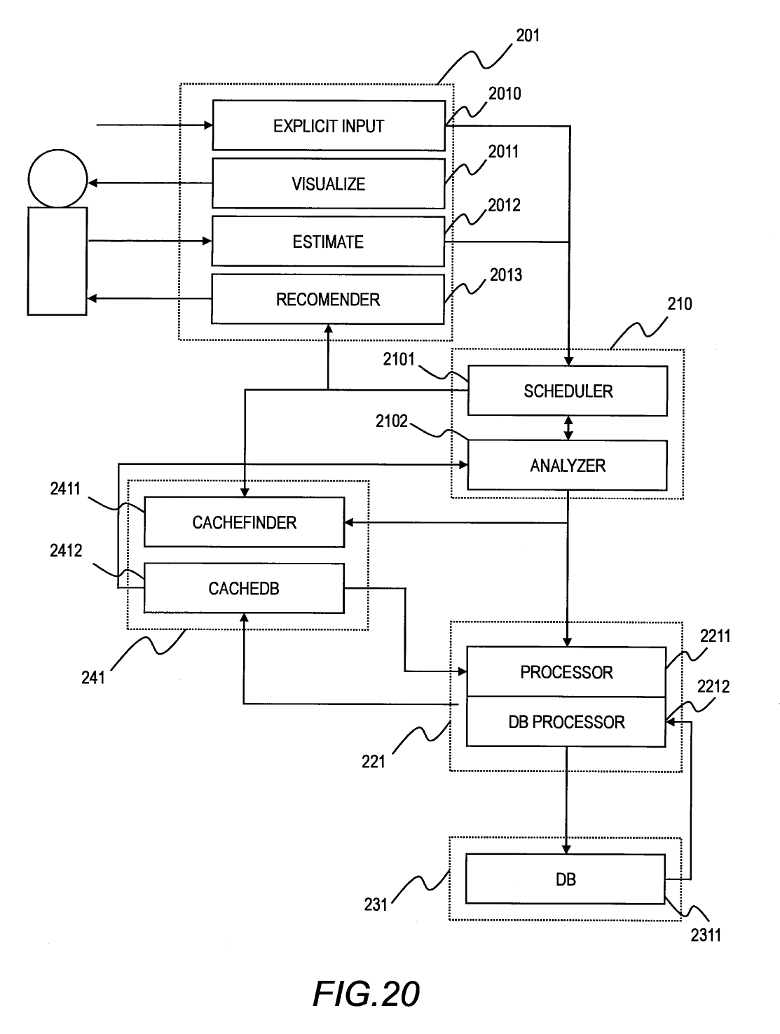

FIG. 20 illustrates a flow of data in this embodiment. In the same manner as in the first embodiment, the scheduler program executed by the server PC receives the tasks of the data analysis requested by the client PC in the form of the data structure, and executes the tasks in order according to the added priority.

In the first embodiment, the script of the data analysis created manually by the user 200 is executed via the analysis processing input program 2010. In the second embodiment, the script of the data analysis is created in two ways.

In one of the ways, in the same manner as in the first embodiment, the analysis is performed according to the script of the analysis procedure that is explicitly input by the user 200 on the client PC 201 through the analysis processing input program 2010. In the other way, the scheduler program 2101 operating on the analysis server PC 210 automatically generates the script of a similar analysis flow obtained by changing the parameters of the input data items in the analysis script with regard to the analysis given the high evaluation, and performs calculation thereof.

First, with regard to the DBs 231 through 233 that retain the raw data to be the analysis subject, description is made of characteristic functions that are different in comparison between this embodiment and the first embodiment. Characteristic differences in a configuration of the second embodiment are a point in which a mechanism for defining a distance function between the data items is provided and a point in which a divided set of small-scale sampling is predefined and the data analysis module 2211 receives the input in units of divided sets. The divided set is a group of data items regarded as being in the same division in terms of space-time data. Examples of such a divided set include one group of data items generated in a given specific area in a given time slot (such as a specific city/town/village and specific one hour). Each divided set is provided with a header area in which metadata is described for describing the data size, the characteristics of the divided set, and a relationship between sets.

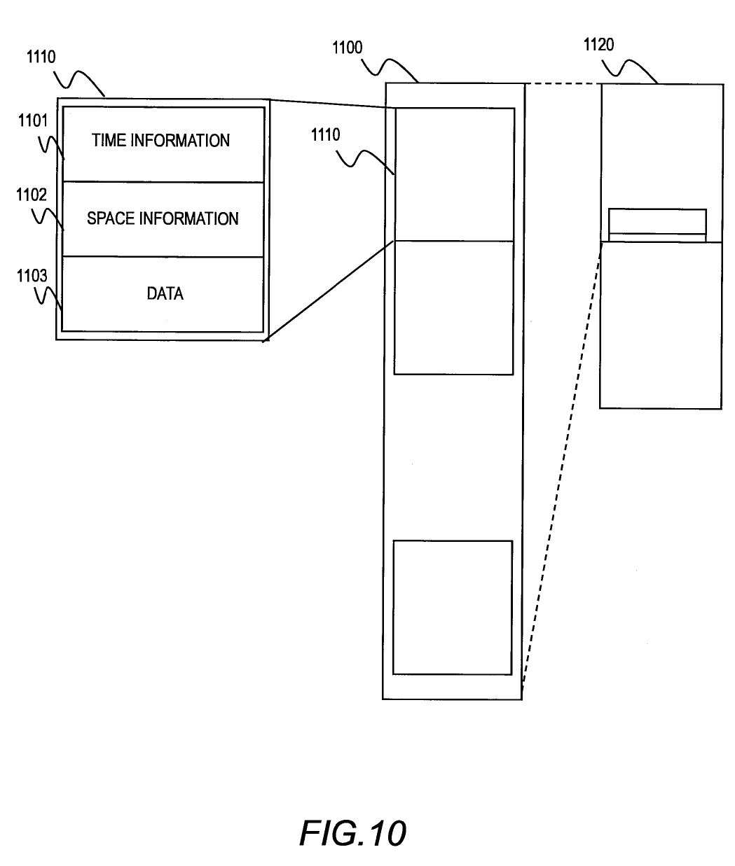

FIG. 10 illustrates an example of a data structure 1100 for realizing the distance function between element data items and the divided set for sampling, and it is assumed that the second embodiment is constructed based on the data structure 1100. In the second embodiment, each element data item 1110 has at least one data item (time information) 1101 for specifying a time and at least one data item (space information) 1102 for specifying a space. Examples of such a data item may include merchandise sales information, ticket distribution information, positional data acquisition information such as GPS, reception information on sensor devices installed in many places, and information on an error log. Further, by appropriately defining the distance function described later, without limiting the position in this embodiment to a physical position on the map, it is also possible that this embodiment is carried out on a concept in a broad sense targeted at a position within a data division relationship map, a Web address, or the like.

On the DB 231, each element data item 1110 is managed after being classified into group data items 1120 based on space and time. In the second embodiment, a classification reference of this group is assumed to be multidimensional classification based on a belonging region, a time, a terminal holder, and the like. Entities of those data items on the DBs 231 through 233 are saved on the information processing device that manages the storage located in the network, and indices that indicate the saved locations in a reference table are saved on the storage (external storage device 307). The contents of those indices are managed on the storage in the units grouped by time and position.

(Distance Function Between Space-time Data Items)

A distance can be defined between the element data items or between the group data items 1120 of FIG. 10 which bind the element data items. The distance is defined based on the time information 1101 and the space information 1102 between the data items. Such a distance is realized by a case of creating the distance dynamically according to a predefined rule, a case of retaining the distance in a table, or a combination thereof.

(Definition of Distance Based on Time Data)

With regard to the distance between groups based on the time (time of day), not only the distance is obtained simply by a difference between the times described in the data items, but also such a definition that data items of the near days in the same week have values close to each other and such a definition that data items of the same date in different years have values close to each other are created, and a synthesized value thereof is used as a comprehensive distance function.

As an example of realization thereof, in this embodiment, if there are two data items of different times, a distance function that registers the value obtained by linearly summing up the following three values as elements of the distance between the data items based on time:

1: the inverse number of the second power of a difference between the times;

2: the inverse number of the second power of a difference between values of the remainders obtained by dividing the times by 24 hours; and

3: the inverse number of the second power of a difference between values of the remainders obtained by dividing the times by a week ((24 hours)×(7 days)=(168 hours)).

Further, the distance between the groups based on space is provided as a simple Euclidean distance on the map, a distance using a travel time by a general transportation means, a distance counted up with the distance between adjacent prefectures set as “1”, or a distance defined as the number of branches when administrative regions are retained as a tree structure.

(Definition of Distance Based on Space Data)

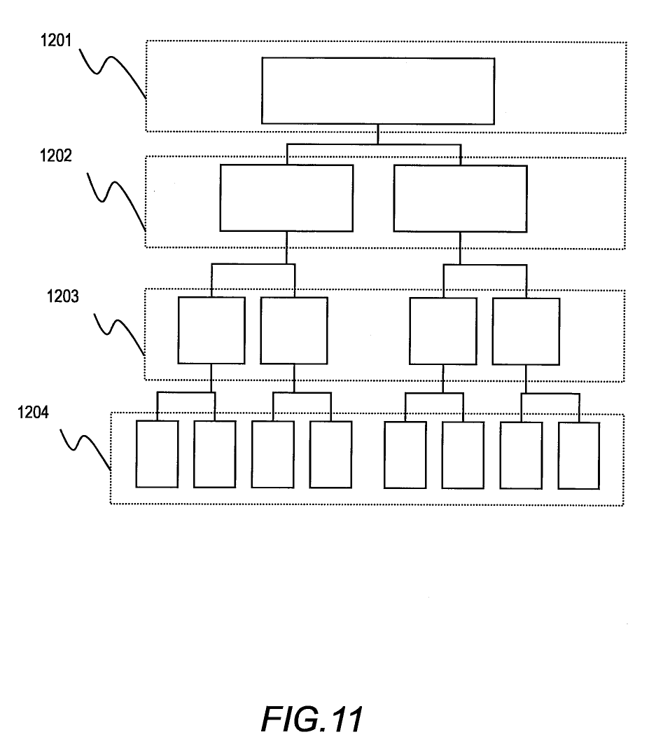

As illustrated in FIG. 11, in the space information in the second embodiment, the groups are organized in the tree structure having a hierarchy of administrative regions (a country 1201, a district 1202, a prefecture 1203, and a city/ward/town/village 1204) to which spatial positions belong. On this precondition, the groups are defined in association with each other as follows. First, if the administrative regions such as a city/ward/town/village and another city/ward/town/village exist in the same category, a value A obtained by multiplying the value of a distance between positions obtained by an arithmetic mean of data by a constant is set as the distance between the data items. If the administrative regions such as a prefecture and a city/ward/town/village which belong to categories different by one tier have a parent-child relationship in the tree structure, a constant B is assigned as the distance. With regard to the distance between positions X and Y which is not assigned according to the above-mentioned rule, such a position Z as to minimize a value of (distance between X and Z)+(distance between Z and Y) is sought, and the value is set as the distance between X and Y.

(Definition of Distance Based on Holder Data)

Further, with regard to the terminal holder of the client PC 201, if there exist categories managed by the tree structure (examples of which may include business categories/franchise groups/each store/each terminal of a corporate entity holding business terminals which are retained in the tree structure and classification of sex/age of holders of individual terminals which is retained in the tree structure) in the same manner as the above-mentioned administrative region, the distance is defined according to the same rule.

(Addition to Scheduler Program)

Next, description is made of contents of changes made to the scheduler program 2101 on the analysis server PC 210 in comparison with the first embodiment.

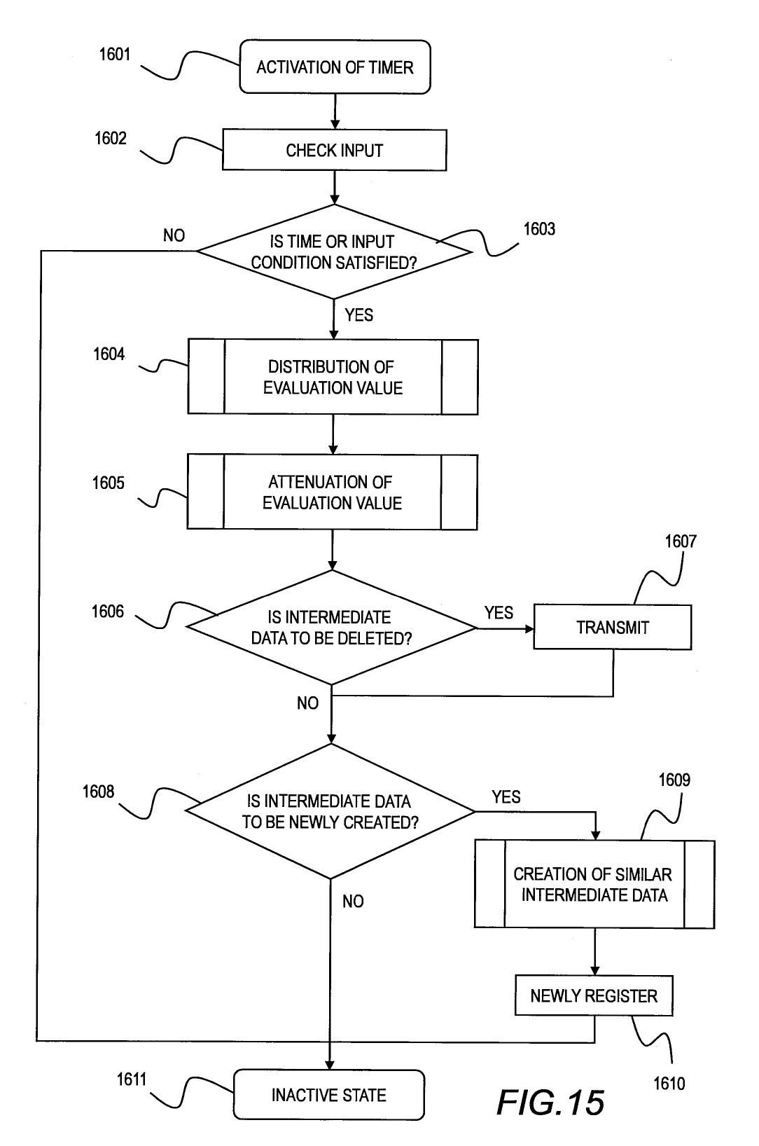

The processing of the scheduler program 2101 described in the first embodiment with reference to FIG. 12 is replaced by a scheduler processing illustrated in FIG. 15. The processing of Steps 1601 through 1607 is the same as the processing of Steps 1301 through 1307 in the first embodiment.

After the search for deletion data in Step 1606, in the second embodiment, if it is judged in Step 1608 that the evaluation value of the intermediate data is larger than a value X2 expressed by Formula (5), the operation for newly creating the similar analysis flow is performed (Step 1609).

X2=m2_{—}s×(S_{—}0—S_{—}c)−m2_{—}t×(T_{—}c)−m2_{—}p×P_{—}c (5)

where S_{—}0 is the remaining capacity of the storage (external storage device 307) of the cache DB 241, S_c is the data size by which the current intermediate data occupies the cache, T_c is the value of the calculation cost (creation turnaround time (total) 804) taken for the analysis to be a reference source, and P_c is a ratio between the current CPU loads on the analysis server PC 210 and the child analysis server PCs 221 through 223.

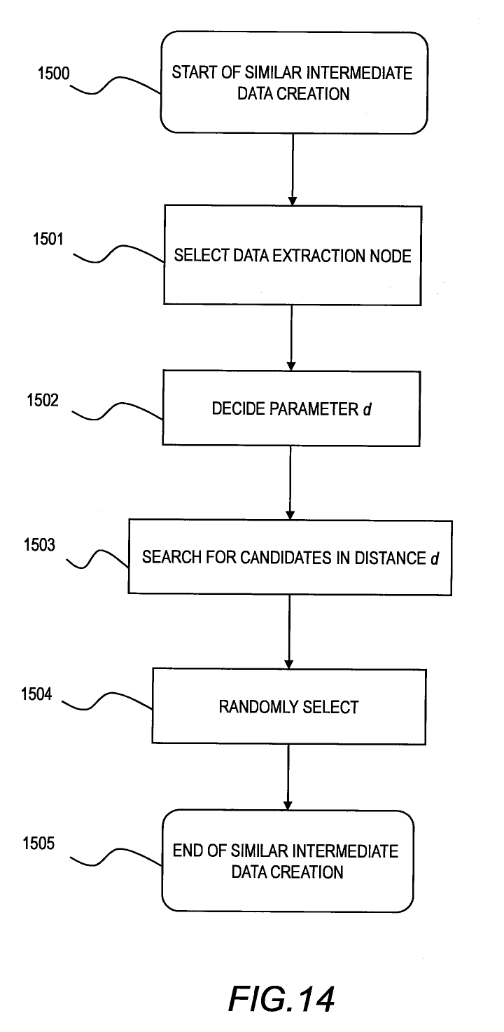

For each of the intermediate data items, if the updated evaluation value is higher than a threshold value determined by the above-mentioned value X2, the creation script of the intermediate data similar to the corresponding analysis contents is generated according to a series of steps described later as illustrated in FIG. 14, and is newly registered as the processing task of the scheduler program 2101 on the analysis server PC 210 (Step 1610).

The scheduler program 2101 is the same as the program for receiving the data analysis flow from the client PC 201, in the same manner as in the case of the transmission from the client PC 201, the intermediate data is created and the result is saved into the cache DB 241.

(Creation of Similar Intermediate Data)

FIG. 14 is a diagram illustrating details of the processing of Step 1610 of FIG. 15, which indicates steps for generating the script of the data analysis flow similar to the intermediate data which is generated from a given analysis flow and has a high evaluation.

In Step 1501, the scheduler program 2101 randomly selects a given data extraction process from among the data extraction processes held in the entire tree structure constituting the analysis flow of an imitation source.

In Step 1502, with regard to the nodes of the corresponding processing, the parameter of the constraint used for the extraction is changed. In this case, in order that a distance d between the extraction data from the original analysis and the extraction data from the new analysis becomes a random number according to a normal distribution, first, the value of the distance d as a parameter is decided (Step 1502). After that, a search is made for data sets having a relationship of the distance d from a set of the analysis subjects in the original analysis (Step 1503). In this case, there exist many possible combinations of candidates for data sets having the relationship of the distance d from the raw data based on a plurality of classification axes of space, time, and the like. One set is randomly selected from among the sets selected as the candidates in Step 1503 (Step 1504).

According to the above-mentioned processing, the data of the analysis processing similar to the intermediate data having the high evaluation is automatically created (Step 1505).

In the second embodiment, the analysis server PC 210 receives the evaluation value (evaluation score) with respect to the result of the analysis previously performed, distributes the evaluation value to a plurality of intermediate data items at a midway stage which compose the analysis, and deletes or saves the intermediate data or creates derivative data thereof according to a magnitude of the evaluation value. The distribution of the evaluation value to the intermediate data items is performed by integrally using the elements, in other words, the time and the calculation needed for the creation of the data, the size of the intermediate data, the remaining capacity of a disk (storage area) available in the cache DB 241, and the time that has elapsed since the browsing or evaluating. Further, for the intermediate data used in a plurality of analysis results, the evaluation values are accumulated one by one, and can be used as a data management reference.

### THIRD EMBODIMENT

(Recommendation)

A third embodiment has the same configuration as the first embodiment except that a configuration in which the user 200 who has requested the analysis of the data is presented on the client PC 201 with an example of the data analysis flow that can be generated by using the already-existing intermediate data similar to a desired analysis and a calculation time required for the analysis (time reduced in comparison with the requested analysis processing of the data) is added to the first embodiment. If the user 200 wishes for execution of the data analysis flow obtained more efficiently which is recommended by the client PC 201, the data analysis flow is given a priority higher than the previous data analysis and transmitted to the scheduler program 2101.

The third embodiment can be carried out by adding the following changes to the first embodiment.

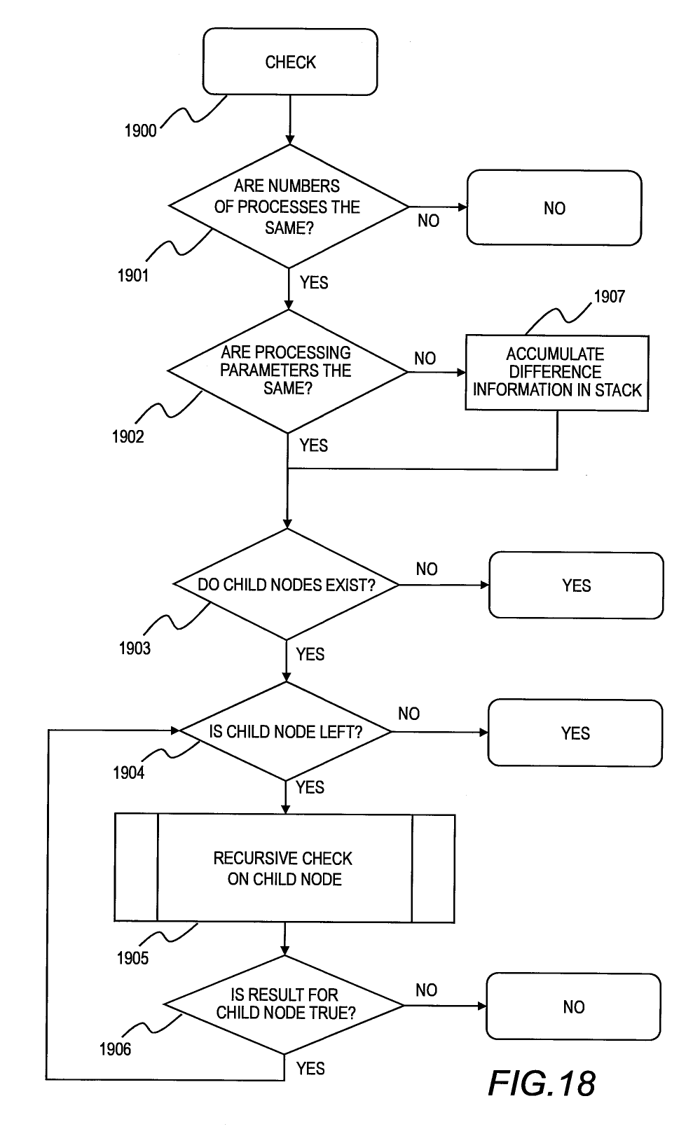

FIG. 18 is a flowchart in which the step flow illustrated in FIG. 8 performed in the first embodiment is changed according to an object of the third embodiment.

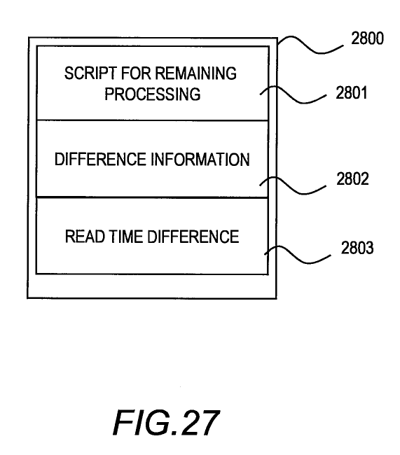

Performed as the processing of Steps 1901 through 1906 is the same processing of Steps 901 through 906 illustrated in FIG. 8 performed in the first embodiment. However, if the comparison results in the difference in Step 1902, instead of returning the value “False” as the return value, the analysis server PC 210 judges that there is an analysis processing result that is not the same but similar, and saves and registers a difference thereof into the stack. To accumulate the difference information in the stack, a structure 2800 illustrated in FIG. 27 is created in Step 1907. The script (obtained by replacing the partial tree by the intermediate data) for a case where a portion judged to be a similar portion within the tree structure of the original analysis is replaced by the intermediate data and the remaining analysis is performed is described in an area 2801. Subsequently, the difference information accumulated in the stack is written into difference information 2802. Further, the difference between the time (already described in the creation turnaround time (total) 804) required to create the corresponding intermediate data and the time (calculated from the data size and a storage access speed) required to read the intermediate data is written into a difference prediction time 2803. The contents are transmitted to the client PC, and the difference information 2802 and the difference prediction time 2803 are presented to the user. If the user performs such an input as to acknowledge the reuse of the data, the data processing written in a script 2801 for a remaining processing is transmitted to the analysis server PC 210.

According to the above-mentioned processing, it becomes possible to feed back the recommendation of the similar analysis flow to the user 200.

### FOURTH EMBODIMENT

In a fourth embodiment, description is made of an example in which a technique for creating the evaluation value from implicit information included in the action of the user 200 for the deleting and updating is added to the first embodiment.

The following work is a description of a mechanism for detecting information from the action of the user 200 itself in Step 507 illustrated in FIG. 4 performed in the first embodiment, in place of the step of explicitly inputting the evaluation numerical value by the user 200.

This step is executed by the evaluation result input program 2012. The evaluation result input program 2012 is a dedicated program for acquiring a behavior of the user 200 who is viewing the viewer program on the client PC 201 and the explicitly-input evaluation value and transmitting the behavior and the evaluation value to the scheduler program 2101 on the analysis server PC 210.

The evaluation result input program 2012 performs estimation as to whether or not the user 200 is interested in the analysis result by a combination of a plurality of evaluation techniques. In this embodiment, the following four analyses (Evaluation references 1 through 4) are performed, and a total value of all the evaluation values is used as the evaluation value.

(Explicit Inputting of Evaluation by User)

In Evaluation reference 1, in the same manner as in the first embodiment, the user himself/herself inputs a numerical value as a satisfaction degree with respect to the analysis result. The numerical value from “0” through “100” input from the interface device (input device) 202 is set as the evaluation value E_{—}1 as it is.

(Presentation/measurement of Observation Time)

In Evaluation reference 2, based on a picture captured by the camera device 204, if the user 200 takes a long time for the observation, on the precondition that the user 200 is highly likely to be interested in the contents presented on the client PC 201, the evaluation is performed based on the time during which the analysis data is being presented. A screen presentation time TS of the analysis result presenting program 2011 that presents the analysis result and a count/of interaction operations performed by the user 200 are used to determine an evaluation value E_{—}2 according to the following Formula (6).

E_{—}2=1/(1+b_{—}21 exp(TS))×p1+1/(1b_{—}22exp(/))×p2 (6)

where b_{—}21 and b_{—}22 are constants, and p1 and p2 are weighting parameters (constants) that satisfy “p1+p2=100”.

(Recording of Utterance Count)

In Evaluation reference 3, in a case where a plurality of users 200 are browsing the data, if there are many utterances among the users 200, it is assumed that a discussion concerning the presented contents is highly likely to be performed actively, and the evaluation is calculated based on an utterance duration of this time. A sum TV of the utterance durations of voice information captured by a microphone is counted, and an evaluation value E_{—}3 is determined by the following Formula (7).

E_{—}3=1/(1+b_{—}3exp(TV))×100 (7)

where b_{—}3 is a constant.

(Extraction of Sight Line)

In Evaluation reference 4, judging from the picture captured by the camera device 204, if the time during which the sight line of the user 200 is being directed toward a screen surface is long in terms of the time during which the information is being presented on the client PC 201, it is assumed that the user 200 is highly likely to be interested in the presented contents, and the evaluation is performed based on the time during which the sight line of the user 200 is being directed toward the screen surface. A facial area is extracted from the image captured by the camera device 204 placed on the side of the screen, and a time period during which the sight line is being directed toward the screen is measured (however, there exist many prior arts for a technology for measuring the sight line from a moving image, and detailed description thereof is omitted).

A sum TE of the periods during which the sight line of the user 200 is being directed toward the screen surface is counted, an evaluation value E_{—}4 is determined by the following Formula (8).

E_{—}4=1/(1+b_{—}4exp(TE))×100 (8)

where b_{—}4 is a constant.

(Sum of Evaluations)

A weighted mean value of the evaluation values E_{—}1 through E_{—}4 obtained in Evaluation references 1 through 4 is obtained as in the following Formula (9), and is set as the evaluation value ED_p of data D_p.

ED_{—}p=¥sigma_{—}{i=0}̂4m_{—}i×E_{—}i (9)

The evaluation value ED_p is transmitted to the scheduler program 2101 on the analysis server PC 210.

According to the above-mentioned processing, it is possible to extract information from the action taken by the user 200 during the observation of the analysis data, and use the information for the management of the data.

### FIFTH EMBODIMENT

In a fifth embodiment, a mechanism is added in which, when a plurality of users 200 view the analysis result at remote sites by using a network environment such as WWW, the explicit evaluation of the analysis result or the evaluation value (browsing information) of the analysis contents extracted from an implicit action is used to perform the management of the intermediate data on the analysis as in the first embodiment and the creation of the new analysis data as in the second embodiment.

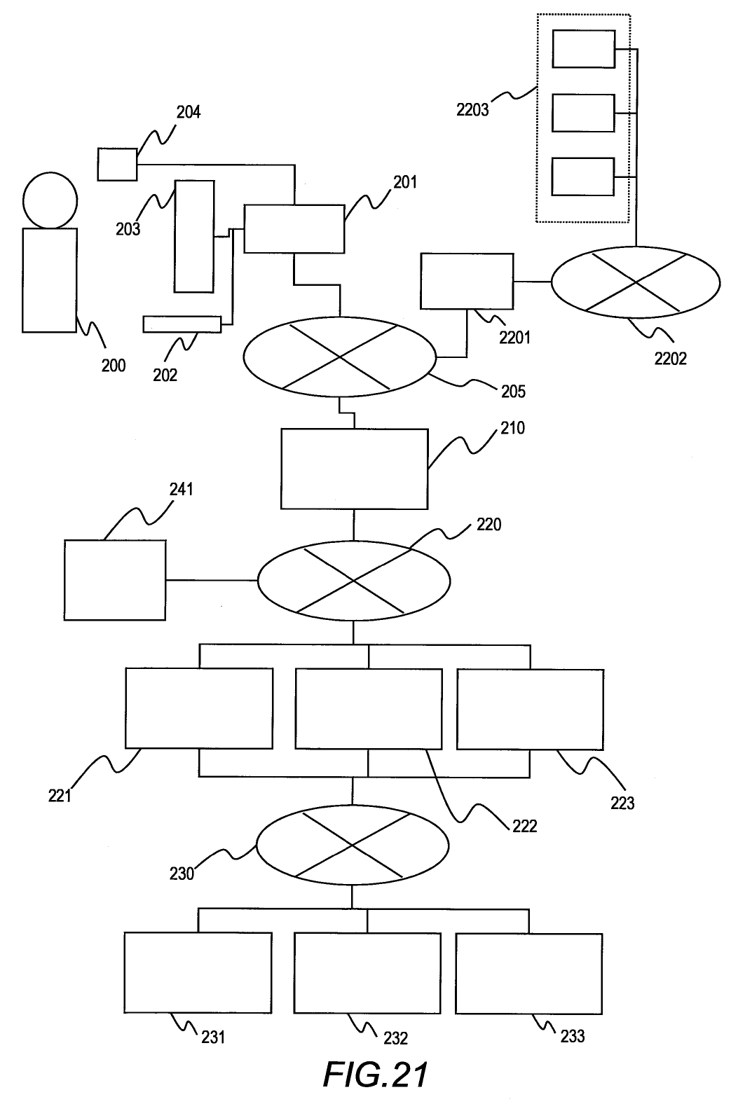

A configuration of the fifth embodiment is illustrated in FIG. 21. The visualization data on the analysis result is made public on a Web network 2202 so as to allow the browsing thereof to be performed by not only the users 200 but also an indefinite number of users or a registered member who has input a password. For realization thereof, in order to distribute the same data as that of the visualization module 2011 transmitted to the client PC 201, a Web server 2201 is installed to distribute a visualization program 2300 that can display the analysis result on a Web browser in response to requests from a plurality of information processing devices 2203 connected to the network.

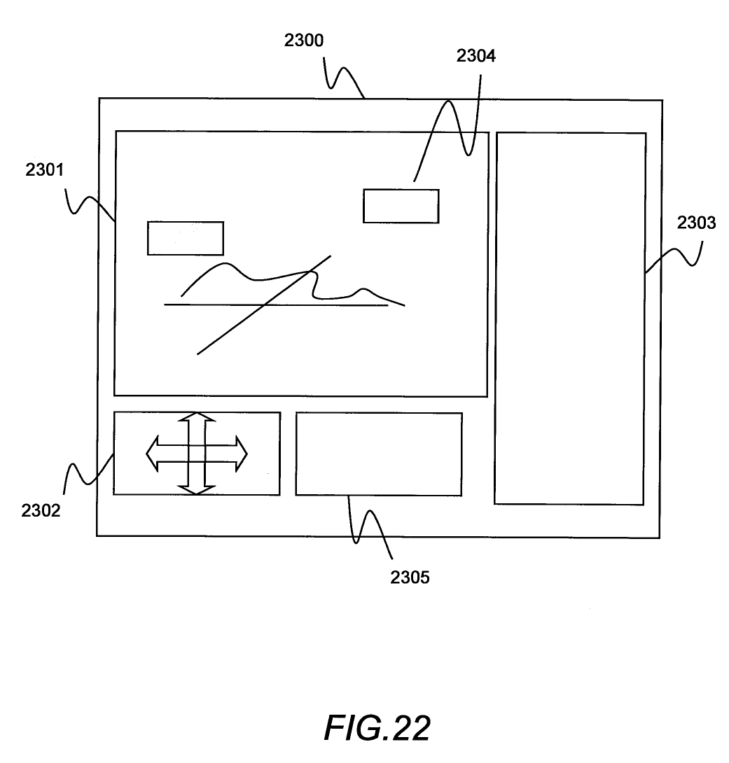

FIG. 22 illustrates an example of a screen of the visualization program 2300. The visualization program 2300 is implemented by a program for presenting the picture after executing the processing on such a general-purpose computer as illustrated in FIG. 2. An implementation of screen display and interaction thereof can be realized by diverting a currently-used Web browser and each of technologies used therefor. Here, an area 2301 is used for visualizing the analysis result on the screen and display the analysis result onto the screen, and can display the picture by changing a point of view, the view angle, a magnification, and the like through clicks on an input area 2302.

Further, with regard to the analysis result, a bulletin board system 2303 in which opinions are exchanged in text is simultaneously presented. Further, a system 2304 for writing an annotation in association with a coordinate position of the visualization data on the analysis is simultaneously presented. Further, an area 2305 is used for entering a numerical value as the evaluation after the viewing of the analysis data.

The visualization program 2300 transmits a browsed time and a processing log to the Web server 2201 at the end. Further, if a numerical value is entered in the area 2305 for an evaluation questionnaire regarding the analysis, the data on the numerical value is also transmitted to the Web server 2201. The data items entered therein are transmitted to the Web server 2201 and archived thereon, and the information is shared among the users. Such a data management system on the Web can be implemented by using the existing prior art. Further, the Web server 2201 is a program for receiving the evaluation from each of those browsing users.

In Step 507 of FIG. 4 performed in the first embodiment, the following four analyses are performed in place of the evaluation numerical value explicitly input by the user 200, and the sum of all those evaluation values is used as the evaluation value.

(Evaluation Value Average)

A mean value W1 of the evaluation values input to the client PC 201 is converted into the evaluation value by being normalized as E_w1 in the following Formula (10).

E_{—}w1=1/(1+c_{—}1exp(W1))×100 (10)

(Download Count)

A count W2 of downloads of the visualization program 2300 from the Web server 2201 in the fifth embodiment is obtained, and the value of the count W2 is converted into the evaluation value by being normalized as E_w2 in the following Formula (11).

E_{—}w2=1/(1+c_{—}2exp(W2))×100 (11)

(Page Rank)

By using a crawling system on the Web, the number of pages describing a connection URL to the analysis data on the Web server 2201 is counted from general Web information, and is set as a value W3 (further, if an estimated access count to each page or the like can be acquired in this case, the value of the estimated access count is regarded as the weighting number). The value W3 is converted into the evaluation value by being normalized as E_w3 in the following Formula (12).

E_{—}w3=1/(1+c_{—}3 exp(W3))×100 (12)

(Amount of Description on Bulletin Board)

The number of characters W41 of posts submitted to the bulletin board system and a post count W42 are used as an evaluation amount. The number of characters W41 and the post count W42 are converted into the evaluation value by being normalized as E_w4 in the following Formula (13).

E_{—}w4=1/(1+c_{—}41exp(W41))×50+1/(1+c_{—}42exp(W42))×50 (13)

(Amount of Added Annotations)

The number of the post count W5 is used as the evaluation amount. The number of the post count W5 is converted into the evaluation value by being normalized as E_w5 in the following Formula (14).

E_{—}w5=1/(1+c_{—}5exp(W5))×100 (14)

(Total Display Time Period)

For each of display screens, a display time period during which the viewing is performed is calculated by a difference between a time instant of the download and a time instant of the end of an application. A sum W6 of the display time periods is used as the evaluation amount, and is converted into the evaluation value by being normalized as E_w6 in the following Formula (15).

E_{—}w6=1/(1+c_{—}6exp(W6))×100 (15)

(Sum of Evaluations)

The weighted mean value is obtained in terms of Evaluation references 1 through 4 described above as in the following Formula (16), and is set as the evaluation value ED_p of the data D_p.

E_{—}wp=¥sigma_{—}{p=0}̂7m_{—}i×E_{—}i (16)

The evaluation value ED_p is transmitted to the scheduler program 2101 on the analysis server PC 210.

As described above, as the technique for receiving the evaluation value from the user 200, in addition to the method in which the user 200 inputs numerical data as the evaluation value, such information can be applied as evaluation information as to be obtained by converting the time during which the analysis result is being browsed, a liveliness of a discussion and emotional information involved therein which are obtained from voice data and written text memos, information obtained from an image that captures a facial expression of the browsing user, and other such information.

### SIXTH EMBODIMENT

(Change in Parameter)

In the first embodiment or the second embodiment, the new analysis data is targeted by the work of selecting the data to be the analysis subject. Improvement in calculation efficiency may be recognized by using the synthesis/separation based on the existing output data not only against the change in the number of the input data items for the data extraction module but also against a change in the parameter if there is an inclusion/subset relationship between the input parameters for the analysis processing modules and if the reuse of the intermediate data is possible. In this embodiment, description is made of a method of implementing a method of using the intermediate data according to such a change in the parameter.

(With Regard to Combinability/Separability of Parameters of Analysis Processing Program)

With regard to each of the data analysis module 2102, if a parameter other than the input data items is changed, the inclusion relationship is built between parameters at a time of the execution of the analysis in order to examine whether or not the intermediate data is reusable, and if a parameter A and a parameter B are not the same, it is examined whether or not there is the inclusion relationship between the parameter A and the parameter B.

Typical examples of a processing that allows a processing accompanying a result of changing such parameters include:

(i) a case where a range of a moving-average is increased in a moving-average calculation processing for time-series data; and

(ii) a case where all frequency components resulting from a Fourier transform are retained as the intermediate data with respect to a computation for finding a power ratio in a specific frequency band by performing the Fourier transform.

If there is the inclusion relationship between the parameters, in the same manner as in the above-mentioned processing for the input data items, it is examined whether or not a scheme for the synthesis processing (combination/reduction processing) for realizing the reuse of the corresponding intermediate data is realized in the module, and if the synthesis of the parameters is impossible, the value “False” is returned.

However, the processing for combining/reducing the analysis processings different in the parameter (in the same manner as the functions f1 and f2 in the first embodiment) is defined as follows.

h1(g(A,x),g(B,x))=g(A+B,x) (3′)

h2(g(A+B,x),A)=g(A,x) (4′)

where g(A, x) is a function indicating a processing of an analysis processing program for the input data item x and the parameter A, A and B are conditional expressions, A+B is union of the parameters A and B. h1 is a function for calculating an output result g(A+B, x) of the parameters A+B that include/synthesize the parameter A and the parameter B from two outputs g(A, x) and g(B, x) to which the parameter A and the parameter B are applied. And h2 is a function for calculating an output result g(A, x) when the output result g(A+B, x) of the parameters A+B and a subset A of A+B are specified.

With regard to the module that can realize those processings, in the same manner as in the first embodiment, by creating an analysis flow alteration script, it becomes possible to use the intermediate data even against the change in the parameter.

It should be noted that the example of executing the processings on a plurality of computers in the above-mentioned embodiments, but the processings may be executed on one computer.

As described above, in the above-mentioned embodiments, it is possible to save the data generated at an intermediate stage of the analysis, receive quantified feedback information for the saved data as the evaluation value, and preferentially delete the intermediate data the evaluation value of which satisfies a predetermined condition while saving the intermediate data the evaluation value of which does not satisfy the predetermined condition, which makes it possible to perform the analysis by reusing the intermediate data at the next analysis. Accordingly, it is possible to realize a high speed analysis processing using the intermediate data while preventing the area for saving the intermediate data from becoming excessively large.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A data analysis system for analyzing raw data and outputting an analysis result by using a computer comprising a processor and a storage device, comprising:
a raw data storage module for storing the raw data;
an analyzing module for reading the raw data, performing an analysis thereon, generating intermediate data in a process of the analysis, and outputting the analysis result;
an intermediate data storage module for storing the intermediate data generated by the analyzing module; and
an evaluation receiving module for receiving an evaluation value regarding the analysis result output by the analyzing module, wherein:
the analyzing module references usable intermediate data among the intermediate data within the intermediate data storage module at a time of the analysis; and
the evaluation receiving module distributes the evaluation value to the intermediate data corresponding to the evaluation value, and if the distributed evaluation value satisfies a predetermined condition, deletes the intermediate data corresponding to the evaluation value.

2. The data analysis system according to claim 1, wherein the analyzing module receives an analysis content, stores the analysis content onto the storage device, judges whether or not the analysis content and a past analysis content are similar to each other, and if the judgment results in similarity, generates, from the past analysis content and the received analysis content, a new analysis content that references the intermediate data in the intermediate data storage module to execute the new analysis content.

3. The data analysis system according to claim 1, further comprising a display module for displaying the analysis result,
wherein the evaluation receiving module receives the evaluation value regarding the displaying of the display module.

4. The data analysis system according to claim 1, wherein the analyzing module receives an analysis content, stores the analysis content onto the storage device, judges whether or not the intermediate data used for the analysis content and past intermediate data are similar to each other, and if the judgment results in similarity, generates new intermediate data by referencing, among the past intermediate data, the intermediate data used for the received analysis content from the intermediate data storage module to execute the analysis content by using the new intermediate data.

5. The data analysis system according to claim 1, wherein the evaluation value comprises at least one of a calculation cost taken for creation of the intermediate data, a size of the intermediate data, and a remaining capacity of the storage device.

6. The data analysis system according to claim 3, wherein the evaluation value comprises browsing information regarding the analysis result displayed in the display module.

7. A data analysis method of analyzing raw data and outputting an analysis result by using a computer comprising a processor and a storage device, comprising:
reading the raw data stored in the storage device;
generating intermediate data from the read raw data;
storing the intermediate data onto the storage device;
computing the analysis result from the intermediate data;
outputting the analysis result; and
receiving an evaluation value regarding the output analysis result, wherein:
the computing the analysis result from the intermediate data comprises referencing usable intermediate data among the intermediate data at a time of the analyzing; and
the receiving an evaluation value regarding the output analysis result comprises distributing the evaluation value to the intermediate data corresponding to the evaluation value, and if the distributed evaluation value satisfies a predetermined condition, deleting the intermediate data corresponding to the evaluation value.

8. The data analysis method according to claim 7, wherein the computing the analysis result from the intermediate data comprises receiving an analysis content, storing the analysis content onto the storage device, judging whether or not the analysis content and a past analysis content are similar to each other, and if the judgment results in similarity, generating, from the past analysis content and the received analysis content, a new analysis content that references the intermediate data to execute the new analysis content.

9. The data analysis method according to claim 7, wherein:
the outputting the analysis result comprises displaying the analysis result onto a display module of the computer; and
the receiving an evaluation value regarding the output analysis result comprises receiving the evaluation value regarding the displaying of the display module.

10. The data analysis method according to claim 7, wherein the computing the analysis result from the intermediate data comprises receiving an analysis content, storing the analysis content onto the storage device, judging whether or not the intermediate data used for the analysis content and past intermediate data are similar to each other, and if the judgment results in similarity, generating new intermediate data by referencing, among the past intermediate data, the intermediate data used for the received analysis content to execute the analysis content by using the new intermediate data.

11. The data analysis method according to claim 7, wherein the evaluation value comprises at least one of a calculation cost taken for creation of the intermediate data, a size of the intermediate data, and a remaining capacity of the storage device.

12. The data analysis method according to claim 9, wherein the evaluation value comprises browsing information regarding the analysis result displayed in the display module.
